(19) United States
(12) Patent Application Publication
(10) Pub. No.: US 2018/0011627 A1
(43) Pub. Date: Jan. 11, 2018

(54) MEETING COLLABORATION SYSTEMS, DEVICES, AND METHODS

(71) Applicant: SIRACUSANO

(72) Inventor: Louis Siracusano, JR., Northvale, NJ (US)

(21) Appl. No.: 15/248,539

(22) Filed: Aug. 26, 2016

Related U.S. Application Data
(63) Continuation-in-part of application No. 14/740,638, filed on Jun. 16, 2015, now Pat. No. 9,462,017.
(60) Provisional application No. 61/998,039, filed on Jun. 16, 2014.

(51) Int. Cl. G06F 3/0484; H04L 12/18; G06F 17/21; G06F 17/24

(52) U.S. Cl. CPC G06F 3/04845; H04L 12/1813; G06F 3/04842; G06F 17/211; G06F 2203/04803; G06F 17/241

(57) ABSTRACT

A method for conducting a communications session comprising: displaying, by a client device, a communications interface including a first canvas, a second canvas, and a content browser, wherein: the first canvas is arranged to display a media stream, the second canvas is arranged to display a sequence of content items provided by a communications system, and the content browser is arranged to display identifiers for one or more document files that are associated with the communications session; detecting a first input that selects a document file from the content browser; in response to the first input, transmitting, from the client device to the communications system, an instruction to provide a new sequence of content items that corresponds to the document file; and displaying the new sequence of content items in the second canvas, wherein each content item in the new sequence is generated by converting a different portion of the document file from a document format to another format, wherein at least one of the document files identified in the content browser is associated with the communications session before the communications session is started, and the content browser is displayed during the communications session.

### CLAIM OF PRIORITY

This application is a continuation-in-part of U.S. patent application Ser. No. 14/740,638 which claims priority to and the benefit of U.S. Provisional Patent Application Ser. No. 61/998,039, filed on Jun. 16, 2014, the entire contents of which are hereby incorporated by reference herein.

### FIGURE SELECTED FOR PUBLICATION

FIG. 7

### BACKGROUND

### Technical Field

The present disclosure generally relates to browser-based software solutions, and more particularly to an online/virtual content collaboration system.

### Background of Related Art

Many conferences, meetings and training programs in corporate and educational environments require that presenters and attendees actively participate, share, and collaborate on and with a variety of different content types (e.g., images, documents, videos). Increasingly, such conferences and meetings are taking place over the Internet as opposed to in actual face-to-face meetings such that participants may be located in geographically distant locations. However, to date when participants have used “collaboration” technology as an alternative to meeting face-to-face, the level of interaction between participants has typically been hampered by tools that are insufficient to facilitate collaborative efforts to review, discuss, manipulate, and share information in real-time. This has become an enormous challenge in corporate and education environments, where lectured learning sessions, as well as virtual business meetings (where complex information is shared) are being attempted in business centers, conference rooms, classrooms, company boardrooms, and the like across the globe.

### SUMMARY

According to aspects of the disclosure, a method is provided for conducting a communications session comprising: displaying, by a client device, a communications interface including a first canvas, a second canvas, and a content browser, wherein: the first canvas is arranged to display a media stream, the second canvas is arranged to display a sequence of content items provided by a communications system, and the content browser is arranged to display identifiers for one or more document files that are associated with the communications session; detecting a first input that selects a document file from the content browser; in response to the first input, transmitting, from the client device to the communications system, an instruction to provide a new sequence of content items that corresponds to the document file; and displaying the new sequence of content items in the second canvas, wherein each content item in the new sequence is generated by converting a different portion of the document file from a document format to another format, wherein at least one of the document files identified in the content browser is associated with the communications session before the communications session is started, and the content browser is displayed during the communications session.

According to aspects of the disclosure, an electronic device is provided for conducting a communications session, comprising of at least one processor, configured to: present, on a display, a communications interface including a first canvas, a second canvas, and a content browser, wherein: the first canvas is arranged to display a media stream, the second canvas is arranged to display a sequence of content items provided by a communications system, and the content browser is arranged to display identifiers for one or more document files that are associated with the communications session; detect a first input that selects a document file from the content browser; in response to the first input, transmit to the communications system an instruction to provide a new sequence of content items that corresponds to at least a portion of the document file; and display the new sequence of content items in the second canvas, wherein each content item in the new sequence is generated by converting a different portion of the document file from a document format to another format, and wherein at least one of the document files identified in the content browser is associated with the communications session before the communications session is started, and the content browser is displayed during the communications session. These and other aspects of the present disclosure are described herein below with reference to the accompanying drawings.

These and other aspects of the present disclosure are more fully described herein below.

### BRIEF DESCRIPTION OF THE DRAWINGS

By way of description only, embodiments of the disclosure will be described with reference to the accompanying drawings, in which:

FIG. 1 depicts a schematic diagram of a system, according to aspects of the disclosure;

FIG. 2A depicts an embodiment of a graphical user interface for a virtual meeting application, according to aspects of the disclosure;

FIG. 2B depicts a portion of the graphical user interface of FIG. 2A, according to aspects of the disclosure;

FIG. 3 depicts a flowchart of a process performed by the system of FIG. 1, according to aspects of the disclosure;

FIG. 4 depicts a flowchart of a sub-process associated with the process of FIG. 3, according to aspects of the disclosure;

FIG. 5 depicts a flowchart of a sub-process associated with the process of FIG. 3, according to aspects of the disclosure;

FIG. 6 depicts a schematic diagram of a system, according to aspects of the disclosure;

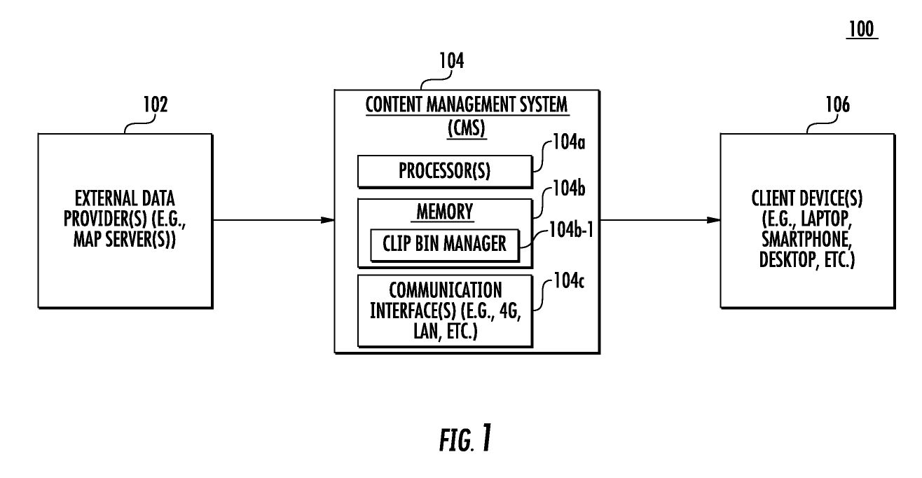

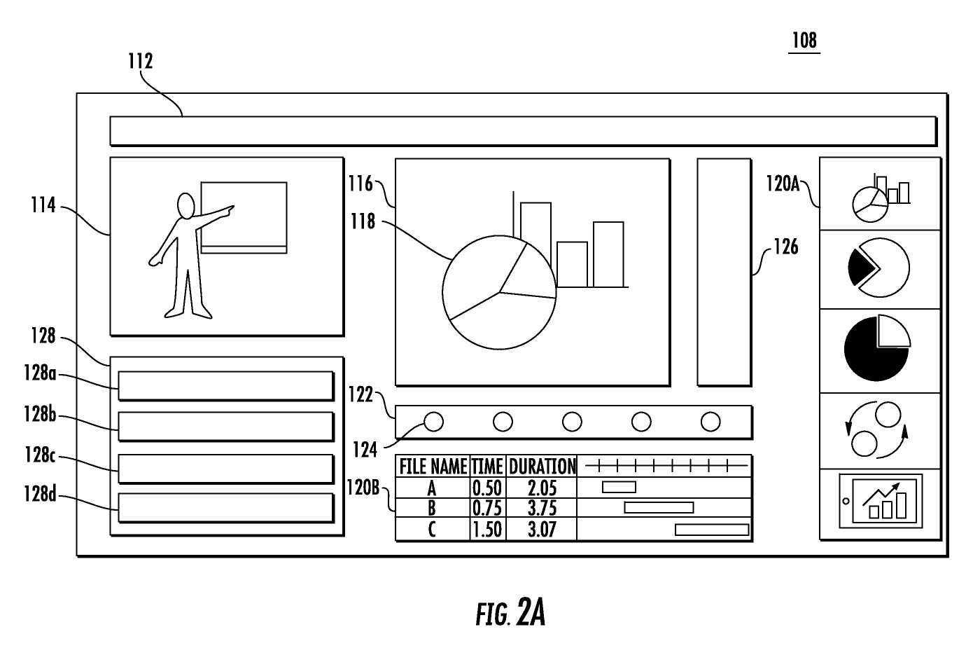

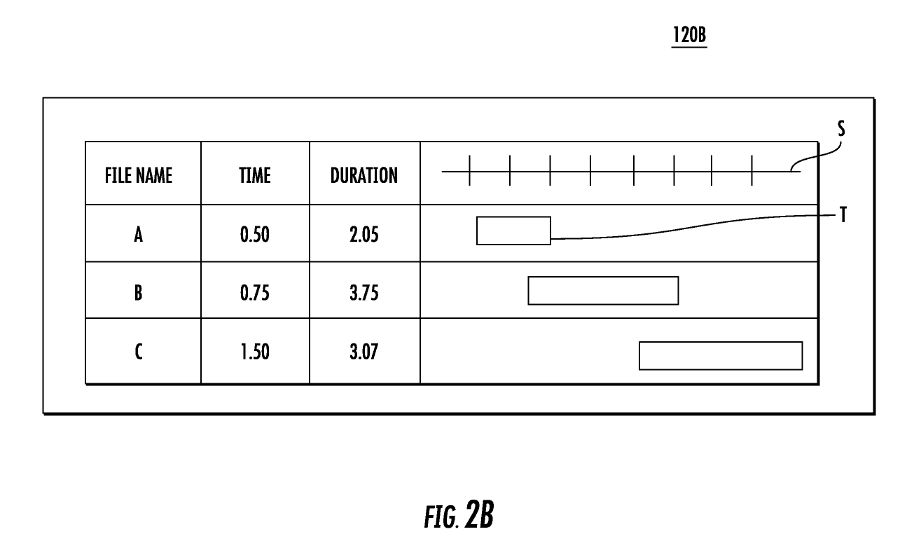

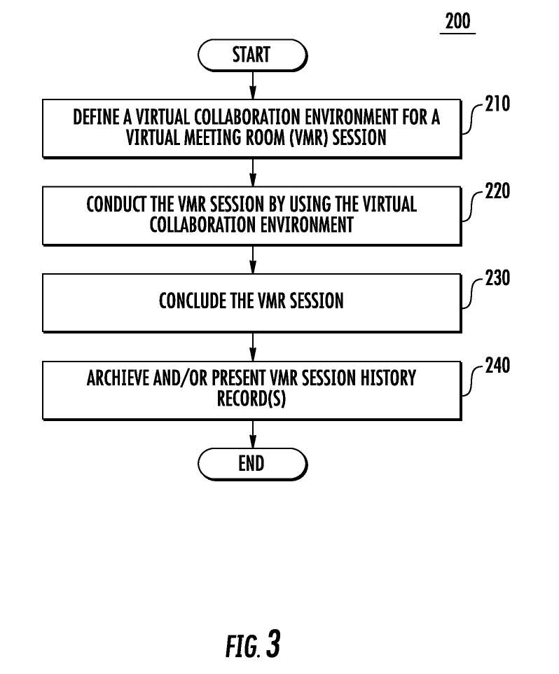

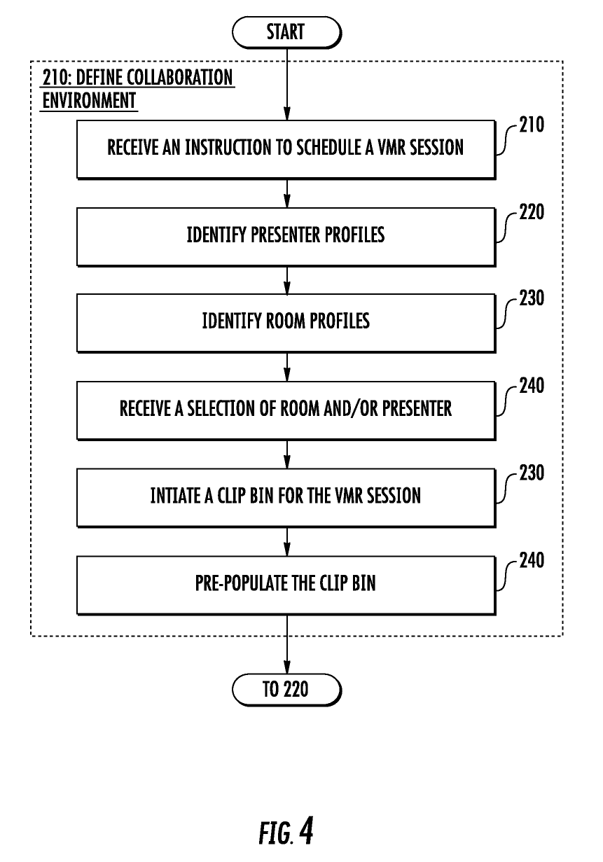

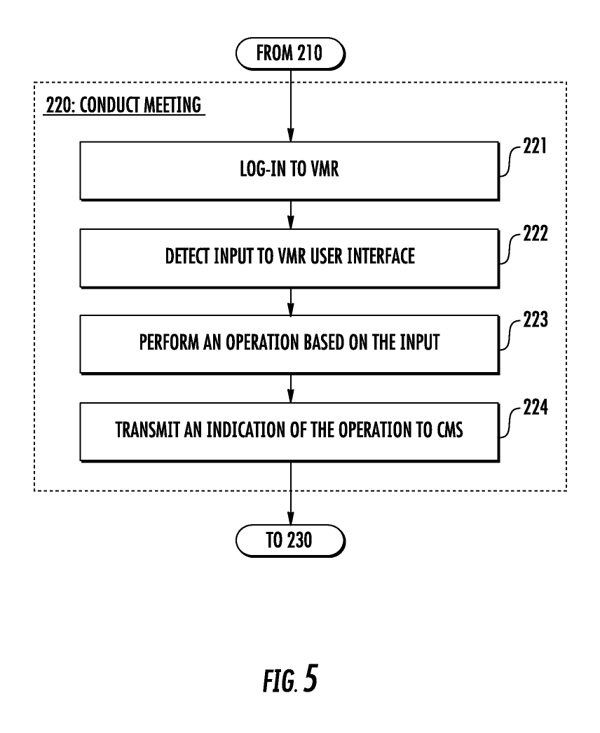

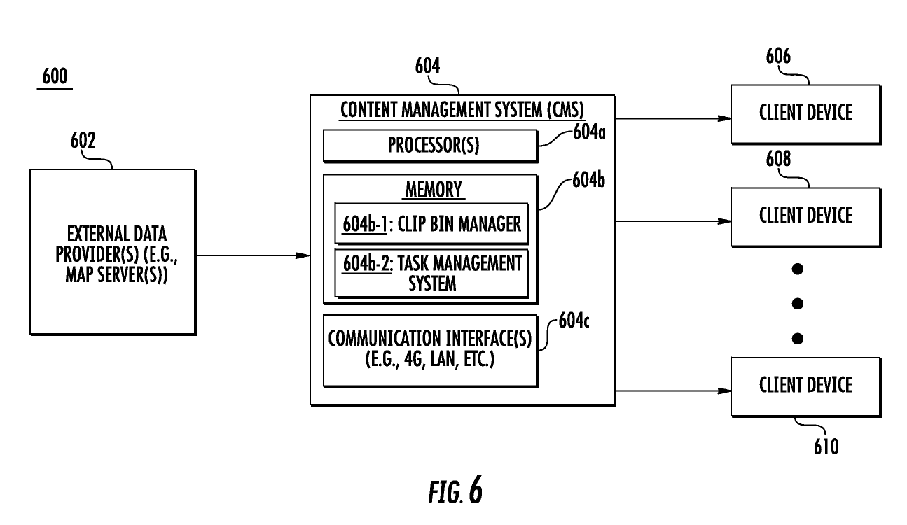

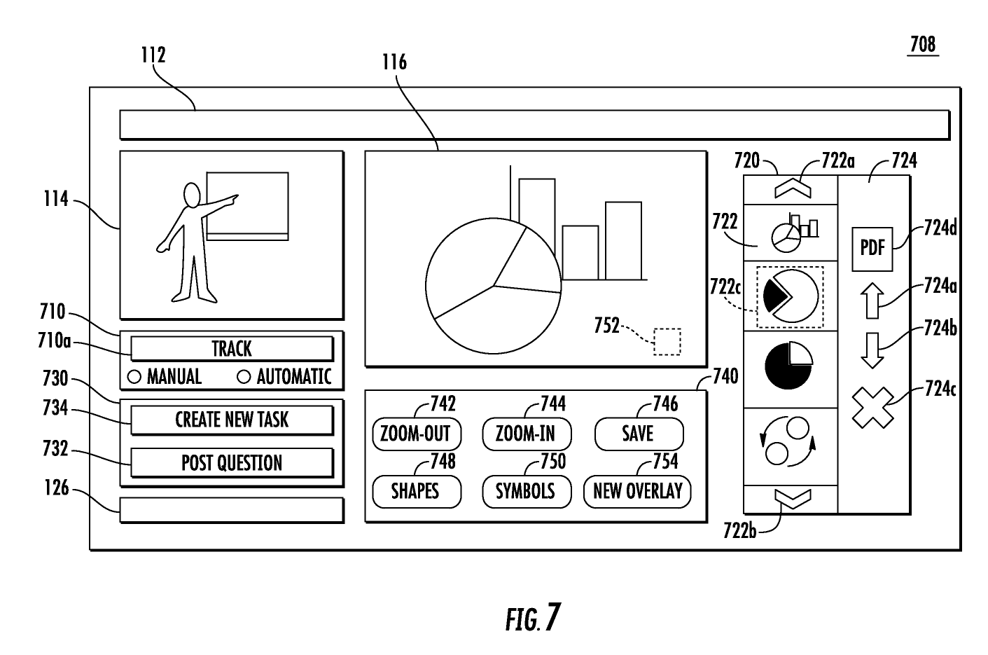

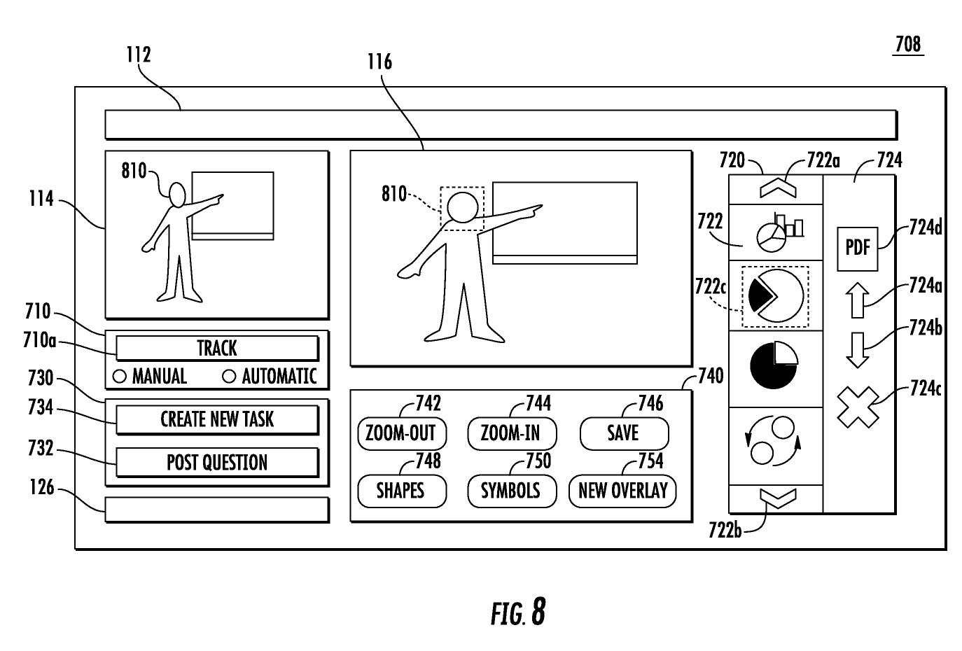

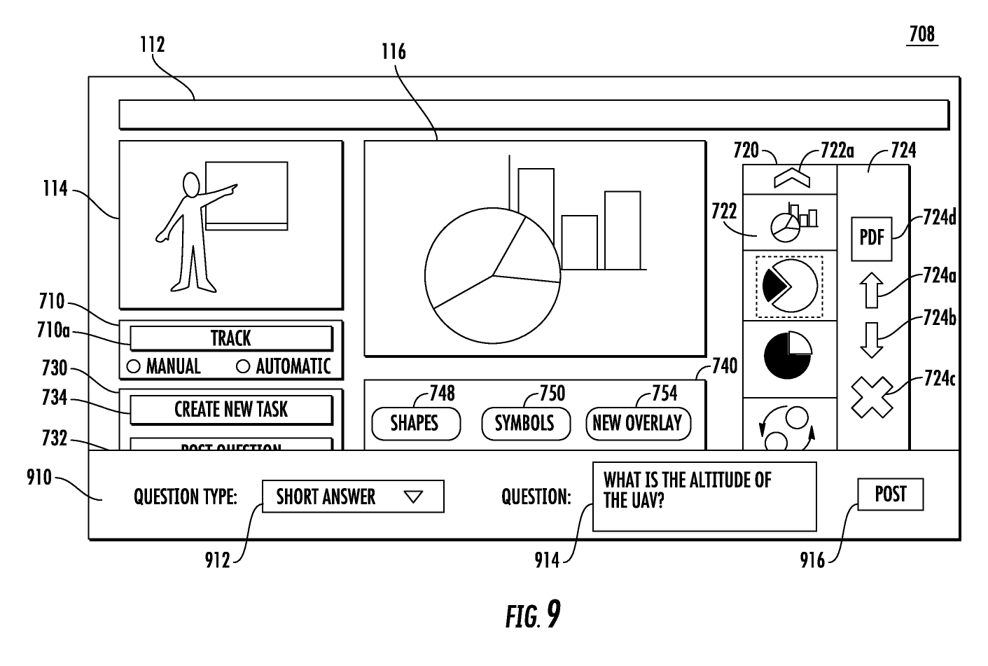

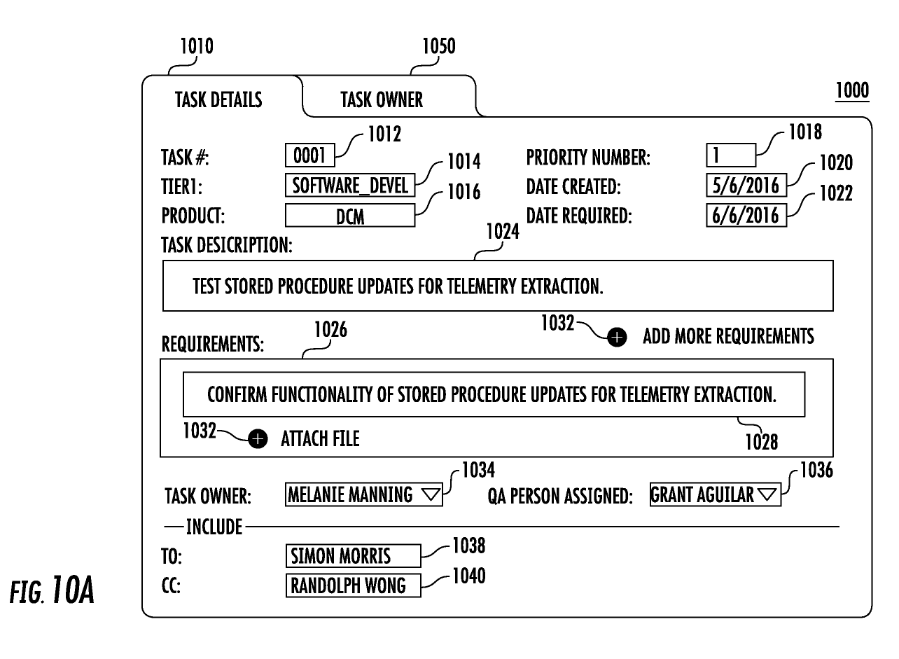

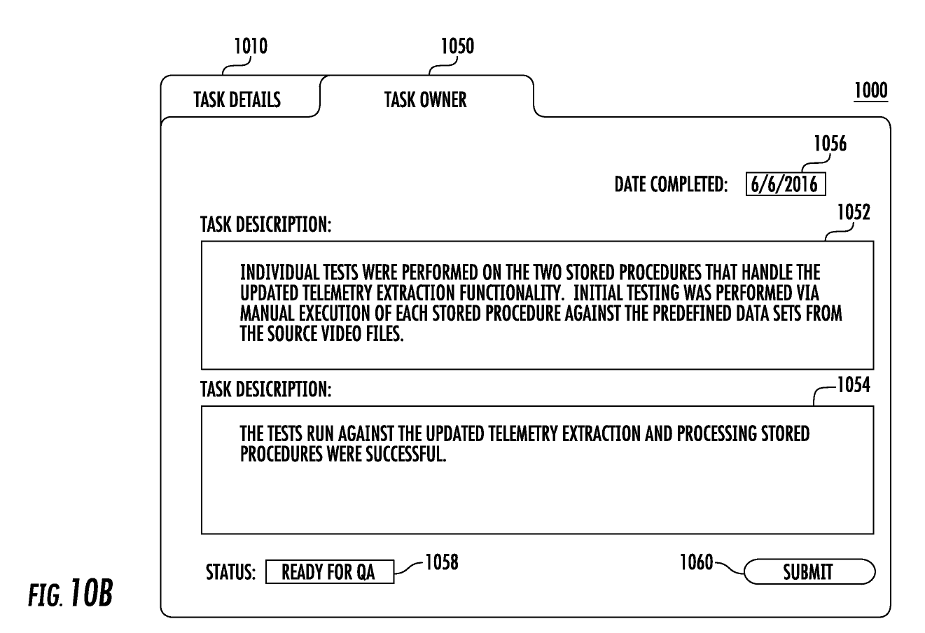

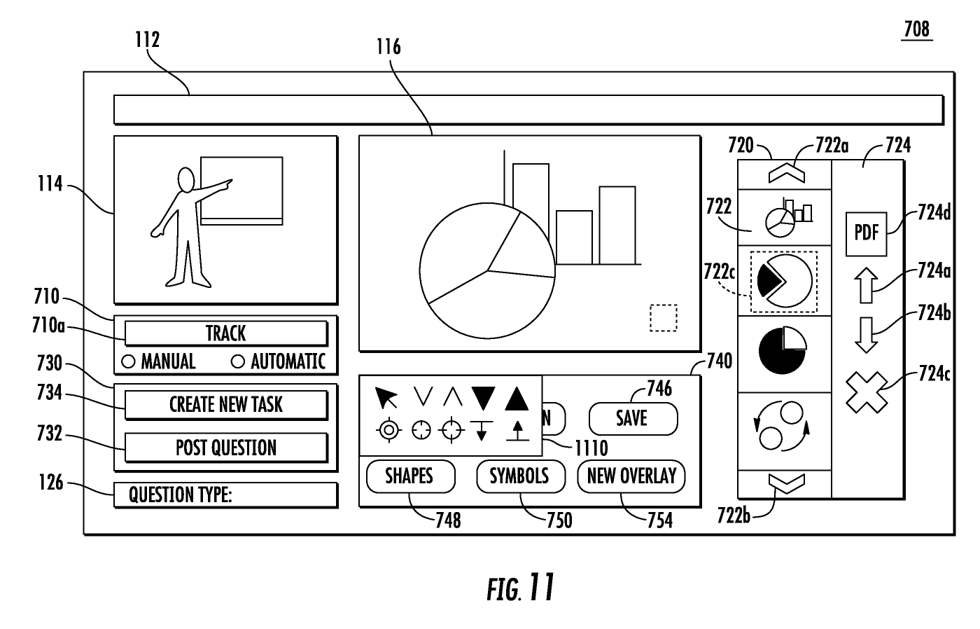

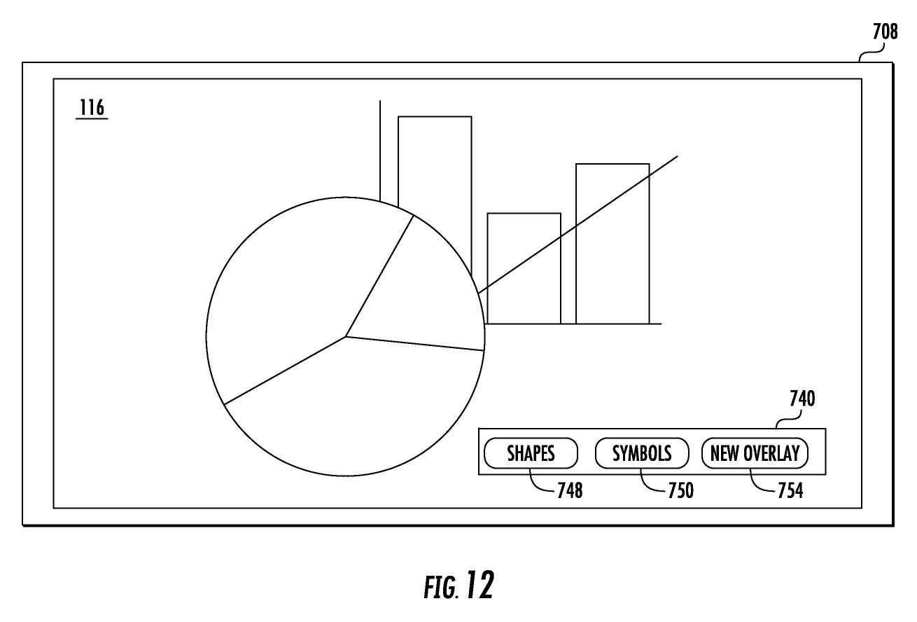

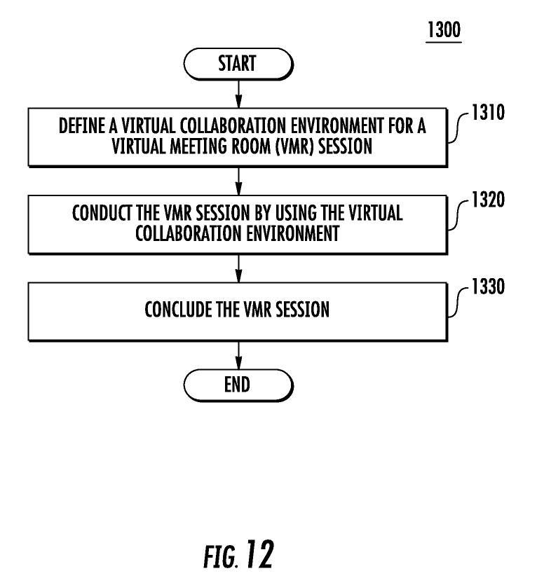

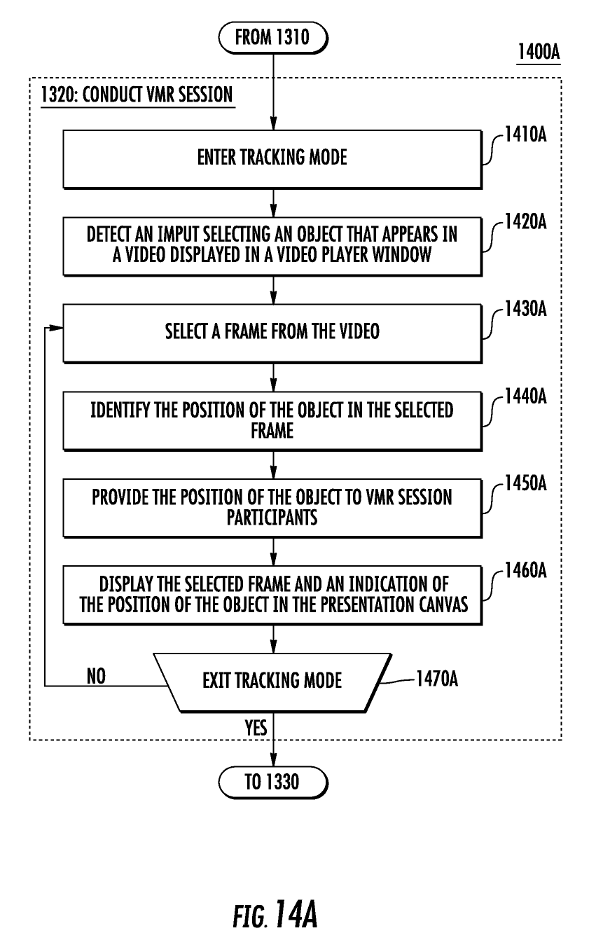

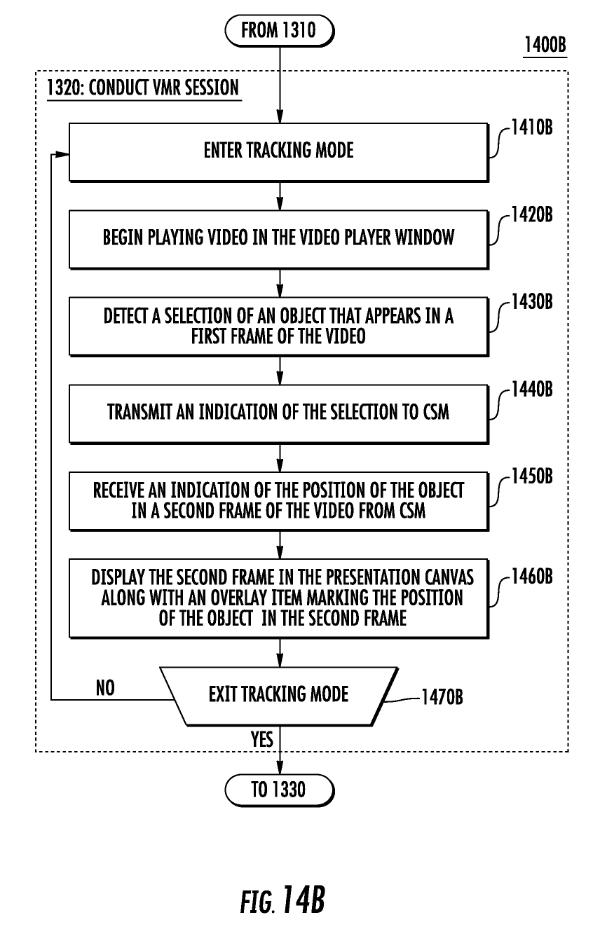

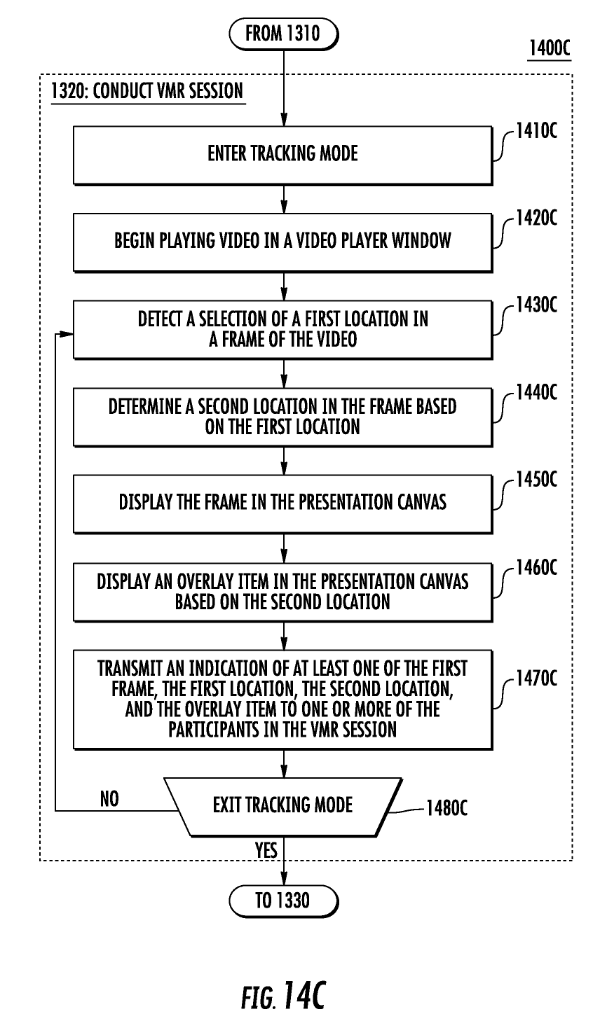

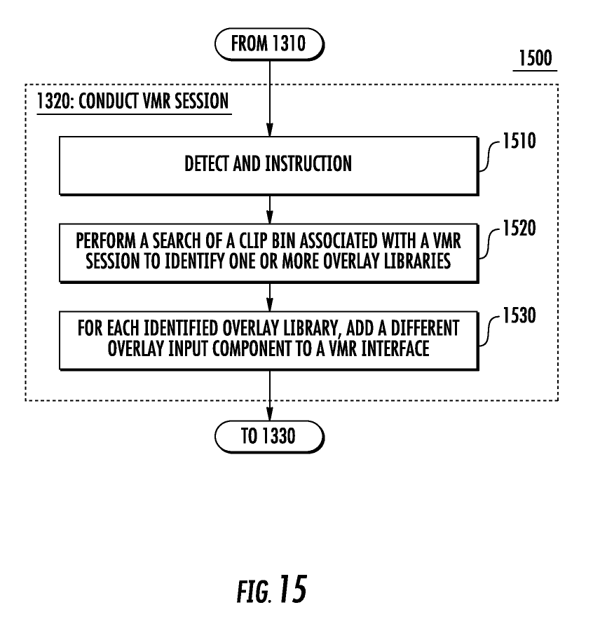

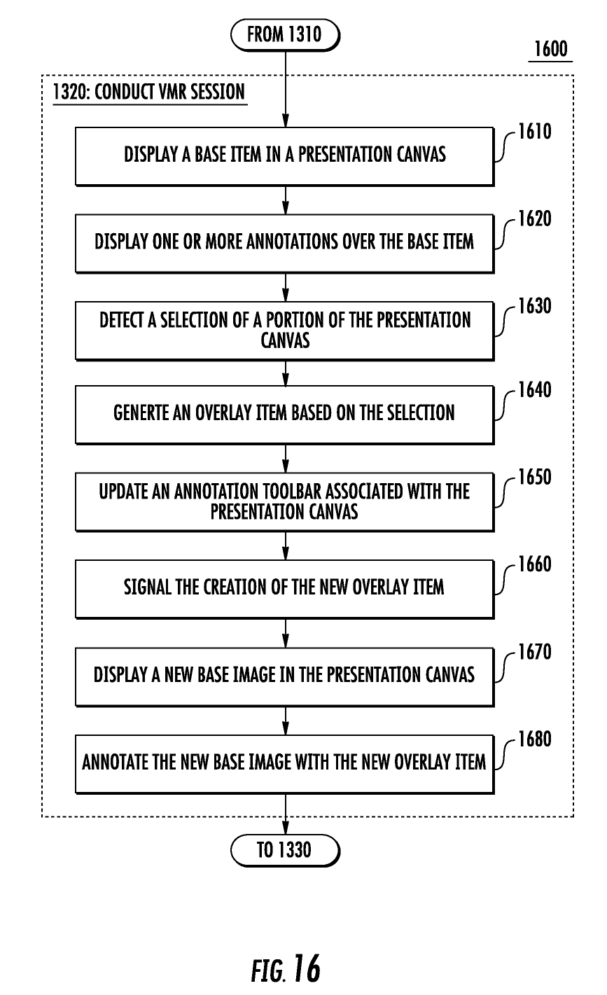

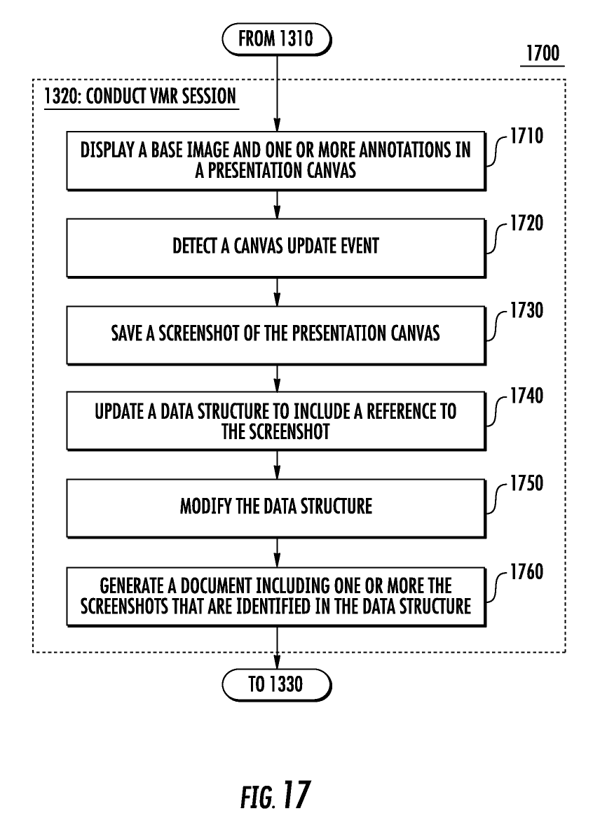

FIG. 7 depicts an embodiment of a graphical user interface for a virtual meeting application, according to aspects of the disclosure;

FIG. 8 depicts an embodiment of a graphical user interface for a virtual meeting application, according to aspects of the disclosure;

FIG. 9 depicts an embodiment of a graphical user interface for a virtual meeting application, according to aspects of the disclosure;

FIGS. 10A-10B depict an embodiment of a task management interface (TMI) according to aspects of the disclosure;

FIG. 11 depicts an embodiment of a graphical user interface for a virtual meeting application, according to aspects of the disclosure;

FIG. 12 depicts an embodiment of a graphical user interface for a virtual meeting application, according to aspects of the disclosure;

FIG. 13 depicts a flowchart of a process performed by the system of FIG. 6, according to aspects of the disclosure;

FIG. 14A depicts a flowchart of a sub-process associated with the process of FIG. 13, according to aspects of the disclosure;

FIG. 14B depicts a flowchart of a sub-process associated with the process of FIG. 13, according to aspects of the disclosure;

FIG. 14C depicts a flowchart of a sub-process associated with the process of FIG. 13, according to aspects of the disclosure;

FIG. 15 depicts a flowchart of a sub-process associated with the process of FIG. 13, according to aspects of the disclosure;

FIG. 16 depicts a flowchart of a sub-process associated with the process of FIG. 13, according to aspects of the disclosure; and

FIG. 17 depicts a flowchart of a sub-process associated with the process of FIG. 13, according to aspects of the disclosure.

### DETAILED DESCRIPTION OF THE PREFERRED EMBODIMENTS

Embodiments of the presently disclosed virtual collaboration system, devices, and methods will now be described in detail with reference to the appended figures, in which like reference numerals designate identical, corresponding, or like elements in each of the several views. In the following description, well-known functions or constructions are not described in detail to avoid obscuring the present disclosure in unnecessary detail. The term “or” as used herein shall be understood to mean both “and” and “or”, that is the word “or” means either or both of the things mentioned.

According to aspects of the disclosure a content system may provide client devices with a browser-based user interface that includes a media player, a presentation canvas, and a clip bin manager. The media player may be arranged to display either a live or previously recorded media stream in a variety of different file formats. The presentation canvas may be arranged to display a sequence of content items that also include digital files in a variety of file formats. The types of file formats could include “Image” (.PNG, JPG, .BMP, .TIFF, etc.), “Video” (.MP4, .WMV, .TS, etc.) and “Document” (.PPT, .DOC, .XLS, .PDF, etc.).

The clip bin manager may permit the selection and display of a variety of different file types onto the content presentation canvas. The clip bin manager may be implemented using processor-executable instructions that are executed by a processor of the content management system and/or using dedicated hardware (e.g., an application-specific integrated circuit ASIC, field-programmable gate array FPGA, etc.) The clip bin manager may be used to present the same file on the respective presentation canvases of different communications session (e.g., Virtual Meeting Room (VMR)) participants. Multi-page files stored using the clip bin module may be selected for display in the presentation canvas requiring that each page of the file be easily viewed and managed within presenter canvas through the use of an image viewer of some kind.

In some implementations, the clip bin manager may be configured to convert any of the files that it is used to present into a uniform format. For example, the clip bin manager may convert each page of an uploaded document file (i.e. .PPT, .DOC, .XLS, .PDF) into an image file for efficient display in any type of web browser. This same application may need to also allow for the processing of image and video files into one or more standardized formats to enhance the efficiency and responsiveness of the content management system.

In some implementations, the browser-based user interface may permit users to place annotations of various kinds onto an image on display in the presenter canvas and then disseminate those image modifications among one or more other client devices that are participating in the online collaboration session. In addition, the method may also include the ability for a participant (not in control of the presentation canvas) to “save and store” a copy of the image in the presenter canvas to make annotations to this copy of the image located in the presenter canvas of their client device, which is viewed by that participant in a separate private canvas hidden from all others. For example, the client device of the participant not in control of the presentation canvas canvas may detect a first input (e.g., the use of a highlighting tool to bring attention to a specific content item) related to the content presentation canvas, and then this same content item displayed in the presentation canvas may be saved and then modified (e.g., by the content management system or the client device) in response to the first input.

In some implementations, an image placed in the presentation canvas that has then been annotated (on the client device of the session participant “in control” of the presentation canvas) can be “saved and stored” into a clip bin that is managed by the clip bin manager. The image may then be presented on a second presentation canvas, one that can only be viewed by the session participant who opened the second canvas.

In some implementations, the content management system may include a centralized electronic device for the recording and managing all aspects of a VMR session to include those session activities taking place in the first canvas and second canvas on the client device of the participant who activated the session record function. This centralized device may include a display, a storage facility and a processor. In some implementations, the processor may be configured to detect the amount of bandwidth available to each client device and then moderate the transfer of data and video accordingly. For example, when the available bandwidth is insufficient for the playback of a video, the processor may transition the content management system into a frame-by-frame mode in which only some of the frames in a video are disseminated. For example, when the content management system is in the frame-by-frame mode, the content management system may disseminate every 10^{th} frame of the video, thereby reducing the video's effective refresh rate below a level at which the video can be played smoothly.

An integrated online or virtual collaboration system (e.g., system 100) is described with reference to FIGS. 1-5.

The system 100 may be configured for use as a web service application that is able to be accessed from either a computer or a mobile device (i.e. tablet or smartphone) and may facilitate a variety of functions or operations including (for example): videoconferencing, digital file display (w/annotation), live video streaming, sharing of stored/retrieved video/image/document files, participant polling, live event recording, file upload and download, chatting and content archive. The system may be utilized via standalone computers (with Public Internet access) or via a network of computers with access to the Public Internet, all of which can be utilizing either high or low bandwidth networks. In an embodiment, the system may be accessed via any of the standard web browser interfaces (i.e. Internet Explorer, Mozilla Firefox, Chrome and Safari) accessible from any client device.

Referring to FIG. 1, a schematic diagram of a system 100 is shown that includes an external data provider 102, a content management system (CMS) 104, and client devices 106.

The data provider 102 may include any suitable type of device that is arranged to transmit data to CMS 104 (in advance of or during a virtual collaboration session) for presentation during a live or recorded virtual event. The data provider 102 may include a map server (e.g., a GOOGLE MAPS or Environmental Systems Research Institute (ESRI) server), a streaming media server (e.g., a streaming video server, a streaming audio server), one or more Internet Protocol (IP) cameras, and/or any other suitable type of data transmitting device. In some implementations, the data provider 102 may be part of a device, such as the IP camera in a fixed position or on a drone or autonomous vehicle, that is operating in the field to collect data in real-time while the ongoing conference is taking place.

The CMS 104 may include one or more database servers, a streaming media server, a file server, or any other suitable type of device that is configured to bring virtual collaboration capability to the client devices 106.

The CMS 104 provides a collaborative environment that may link data, graphics, streaming video, and other digital sources into a private cloud to facilitate presentations, work sharing, research, and other learning activities among participants in geographically disparate locations such that they can participate in a single event or meeting or session. By way of example, the CMS 104 may provide some or all of a rich-media presentation platform; live and recorded video streaming; lecture and event capture services; virtual collaboration and/or social learning sessions; performance measurement analytics; enterprise-grade security for computers and mobile devices; premier content management; and/or centralized event scheduling. It is to be understood that the CMS 104 may include a plurality of servers (or other devices) distributed across multiple locations and technology platforms.

As illustrated, the CMS 104 may include, for example, a processor(s) 104a, a memory 104b, and/or a communication interface(s) 104c (e.g., 4G, LAN, etc.) or any suitable hardware architecture that can be used to implement any of the client devices 106 and/or any server or device that is part of the CMS 104. The CMS 104 may include any suitable type of processing circuitry, such as one or more of a general-purpose processor (e.g., an ARM-based processor or an AMD64-based processor), a Field Programmable Gate Array (FPGA), an Application Specific Integrated Circuit (ASIC), or a Digital Signal Processor (DSP). The memory 104b may include any suitable type of volatile or non-volatile storage. For example, the memory 104b may include a Random Access Memory (RAM), a hard drive (HD), a solid state drive (SSD), a cloud-based storage, a remote storage, or a Network-Accessible Storage (NAS). The clip bin manager 104b-1 may include processor-executable instructions that are arranged to manage and operate a clip bin for a particular VMR. The communications interface 104c may include any suitable type of wired or wireless communication interface, such as an Ethernet interface, a 4G interface, or a Wi-Fi interface.

The client devices 106 may include any suitable type of electronic device capable of interacting with the CMS 104 and participate in one or more virtual collaboration session(s) that are being managed using the CMS 104. For example, any of the client devices 106 may include one or more of a desktop computer, a laptop, a tablet or a smartphone. According to aspects of the disclosure, at least one of the data provider(s) 102 and the device(s) 106 may be connected to CMS 104 via any suitable type of communications, such as, for example, the Internet, a Wi-Fi network, a LAN, a WAN, a 4G network, etc.

FIG. 2A is a diagram of a graphical user interface 108 for participating in a Virtual Meeting Room (VMR) session that is conducted by using the CMS 104. The interface may be presented on any one of the client devices 106 when the client device is used to participate in the VMR. The interface may be either browser-based or an application, such as an iOS/Android Application (App), that can be executed without the need for a web-browser. In instances in which the interface is browser-based, the interface may be provided by the CMS 104 to any of the client devices 106 upon logging to the CMS 104, after which the interface 108 may be displayed in a web browser (e.g., Internet Explorer, Firefox, Chrome, Safari, etc.) As shown best in FIG. 2A, the user interface 108 may provide a rich-media platform in which a given participant in the VMR may receive, send, and/or edit information over the course of the VMR.

As illustrated, the user interface 108 may include a status bar 112 that will display status updates, such as an indication (e.g., visual indication) that is provided when a participant joins and/or leaves the VMR, when a participant takes or releases control of session, when a participant annotates a shared image, as well as a host of other real-time session activities. For example, when a participant is annotating an image, an indication of the type of the annotation (e.g., the type of the annotating tool that has been activated in the toolbar, etc.) may be provided to the other participants. The status bar 112 may also allow a participant to select and/or toggle between a variety of session functions (e.g., login/logout, select clip bin, administration of “live” and/or recorded video streams, selection of video streams in full motion or frame-by-frame mode, chatting, digital note taking, live map view, digital whiteboard, content sharing and annotating, select multilingual audio stream, view logged-in participants, user security settings, etc.).

The user interface 108 may further include the presentation of full motion or frame-based streaming video in the video player window 114. The video player 114 may display the contents of a media stream that is transmitted by the CMS 104. The media stream may include any suitable type of content in either a standard- or high-definition. For example, the media stream may include live video of one of the participants in the VMR (e.g., a lecturer or presenter). As another example, the media stream may include a prerecorded video of a lecture or presentation. As yet another example, the media stream may include a live video stream from an IP camera located on an unmanned air or surface vehicle, a fixed surveillance camera, a hand-held mobile device (such as an iOS or Android device) or a body worn cam (i.e. Go-Pro or any one of many law enforcement video cams).

According to aspects of the disclosure, an administrator of the VMR may select which video stream is to be displayed in the video player window 114. In some implementations, where there is insufficient bandwidth to properly stream video content in a full-motion format, a series of still images (or frames) that are created as part of the media stream, along with corresponding audio, may be automatically provided to the participant (or to the client device executing the interface 108) such that the participant may view (in frame mode) the stream selected by the administrator.

According to aspects of the disclosure, a user participating in the VMR may select (and instantly replay) a portion of content that is streamed (e.g., in full motion format or as a set of frames for replay). The replay may facilitate (1) selecting a single frame to share in the presenter canvas, to then annotate and save, or (2) creating a separate and distinct video file which is automatically saved to the clip bin and Content Management System 104. For example, during the replay, a participant may select a first reference point frame in the content (e.g., a mark-in point) and a second reference point frame in the content (e.g., a mark-out point). In response to the selection, a separate clip may be extracted by the client device of the user from the content that starts with the first reference point and ends at the second reference point. After the clip is created, it may be associated with participant drafted notes and added to the clip bin associated with the VMR session that is currently taking place.

The user interface 108 may further include a presenter's collaboration canvas 116. The presenter's collaboration canvas 116 may display a content 118 that is transmitted by the CMS 104. In some implementations, the content 118 may be a series of images generated through the use of a “.PNG image generation” utility designed to work in conjunction with the CMS 104. For example, a given image in the series may be generated based on a single page that is part of a multi-page document (e.g., a .DOC, .XLS, .PPT or .PDF file). In the event that an 8-page MSWord or PowerPoint file is selected for upload into the VMR Clip Bin/Clip Bin Viewer, eight (8) distinct .PNG files will be created and stored in the Content Management System 104 as a single file (e.g., in the clip bin that is associated with a particular VMR session). Although in this example, PNG images are generated, in other implementations, any suitable web-compatible image format may be used (e.g., JPG).

In some implementations, the CMS 104 may generate a data structure that represents a particular document that is stored in the clip bin. The data structure may include one or more variations of an ID for the document, a file name of the document (e.g., a word doc file, a title of the document, and an identification of a plurality of images (e.g., the PNG image files) that are generated based on the document and may represent different pages from the document, an identification of an order of the plurality of images, etc. When this type of document file is selected for presentation in the collaboration canvas, each of the created .PNG files are presented in the vertical image carousel 120A located along side of the presenter collaboration canvas 116. In some implementations, the CMS 104 may display the PNG images in the carousel 120A based on which PNG images are generated. For example, the CMS 104 may display the PNG files in the carousel 120A in an order corresponding to the original file and based on the data structure.

Any VMR session participant may be given control over the presentation canvas 116 of all participants in the VMR session. In such instances, the user may select a document that the user wants displayed in the presentation canvas and transmit a display instruction to the CMS 104 that identifies the document. In response to the instruction, the CMS 104 may disseminate the first page of the document to all participants in the VMR session along with an instruction that instructs the respective user interfaces 108 of the participants to display the first page in their respective presentation canvases.

In one specific implementation, the VMR session participant given control over the presentation canvas may select the document by dragging the document (e.g., dragging an icon corresponding to the document) from the user's clip bin viewer 126 to the user's presentation canvas 116. In response to the document being dragged, the user's interface 108 may generate and transmit to the CMS 104 a display instruction. The display instruction may include one or more of an instruction to generate a new sequence of content items for display in the presentation canvas (e.g., a new sequence of .PNG files) and an instruction to display the new sequence of content files. Upon receiving the instruction, the CMS 104 may generate the new sequence of content items and transmit at least one of the content items to the remaining participants in the VMR session (and/or the VMR session participant with control over the presentation canvas) along with an instruction to display at least one content item in the remaining participants' presentation canvases 116. As used throughout the disclosure, the phrase “instruction to generate a sequence of content items” may include any instruction that directly or indirectly causes the CMS 104 to generate the new sequence of content items (e.g., sequence of. PNG files) that is presentable in each VMR session participants' presentation canvases. Upon receiving the instruction, each of the remaining VMR session participants (and/or the VMR session participant with control over the presentation canvas) may display the new sequence of content items in the participant's respective presentation canvas.

In addition, the CMS 104 may update a data structure that represents the state of the presentation canvas of each participant in the VMR session. As can be readily appreciated, the data structure may include an ID for the document that is currently on display in the presentation canvases of the VMR session participants, as well as a specific page of the document that is currently on display in the presentation canvases 116 of the VMR session participants. Afterwards, when the user wants another page in the document to be displayed in the respective presentation canvases of the VMR session participants, the user may transmit a corresponding instruction to the CMS 104. The instruction may identify a specific page or it may simply instruct the CMS 104 to display the next page. In the latter case, the CMS 104 may identify the next page by using the data structure.

Additionally, or alternatively, other types of image and video files may be selected for presentation in the presenter collaboration canvas 116. Other file types include (but are not limited to): .JPG, .GIF, .BMP, .TS, .MP4, .MP3 and WMV. Each of these files types can be placed into the Content Management System 104 (e.g., in the clip bin that is associated with a particular VMR session) for subsequent display in the Clip Bin Viewer 126 and launch into the presenter collaboration canvas 116 during a VMR session.

In each implementation, the content 118 may be generated by the CMS 104 and displayed on the client device using the VMR user interface 108. As noted above, a uniform format may be an image format (e.g., .PNG). In generating the images in the content 118 for a particular client device, the CMS 104 may take into account the resources available to the particular client device. For example, if the particular client device has low network bandwidth and/or a small screen, the CMS 104 may create image files in a lower resolution (or color depth) than otherwise.

In some implementations, the CMS 104 may provide (as an alternative to the content 118) a view of a global map using plug-in applications such as Google Earth or ESRI ARCMap to the client device 106, which displays in the presenter collaboration canvas 116 of the user interface 108. For example, the CMS 104 may transmit to the client device 106 multiple different global map views that contain varying “zoomed in” presentations of different focal points (i.e. a city, a sea port, a mountain range, etc.). In this same implementation, the CMS 104 may provide the ability to annotate or markup the full-scale map image and then save the annotated image presented in the collaboration canvas 116 as content 118 for a low-bandwidth consumption view to the client device 106. In another implementation, the full-scale map image placed in the presenter collaboration canvas 116 may be used to directly correlate geospatial and temporal data that is associated with the live or previously recorded video stream being presented in the video player window 114. For example, an IP stream may be transmitted from an external data provider 102 (such as a manned or unmanned aircraft) to the CMS 104. The IP stream may then be forwarded by the CMS 104 to the client device 106 along with an indication of the geo-location of the source of the IP stream (e.g., the manned or unmanned aircraft.) Subsequently, the IP stream may be displayed in sync with the indication of the IP source's location in the collaboration canvas 116, such that each frame that is displayed along with an indication of the IP source's location when the frame was captured.

In some implementations, the User Interface 108 may permit one or more participants to overlay various types of markings or annotations onto the content 118 that is displayed in the presenter collaboration canvas 116. These annotations or markings will include, for example: pen drawing, brushing, text insertion, identifying symbols/markers and/or the use of geometric shapes or objects. The annotated content 118 can then be saved as either (1) a new image file (e.g., a .JPG file) or as an edited version of the source file already present in the clip bin viewer 126. The marked-up or annotated version of the image files may be automatically uploaded to the clip bin by the CMS 104 at which time it becomes available content for presentation in the presenter collaboration canvas 116.

As mentioned previously, interface 108 includes the display and may use clip bin viewer 126. Clip bin viewer 126 may serve as both the primary interface to the CMS 104 and the user interface directory of files available to the participants of a VMR session. The clip bin is digital location in which content saved and/or modified, annotated, or created by participants (prior to or during a VMR session) may be uploaded.

When on display in the VMR user interface 108, the clip bin viewer 126 for a particular VMR session serves as the drop point for any and all files (and file types) that a participant or administrator may want associated with the VMR session. For example, a given participant or administrator may drag and drop into the clip viewer any content (e.g. WORD files, JPEG images, etc.) which the participant or administrator would like to displayed in the collaboration canvas 116 during a particular VMR session. Any content that is dragged into the clip bin viewer 126 during the VMR session may be uploaded to the CMS 104 and made available anywhere on the CMS 104 for both local and global access. In particular, the uploaded content 118 may be available as part of the CMS to facilitate a global and remote communication and collaboration environment. Uploaded content may be captured, stored, and/or archived via enterprise or cloud capture services where they can be later searched, retrieved, and/or analyzed.

In some aspects, when a file is uploaded to the clip bin, metadata for the file may be created. The metadata may be stamped in the file or stored in a separate location. The association of metadata with content placed in the clip bin 126 permits the files (videos, images and documents) placed in the clip bin to be searched or filtered by the participants based on a variety of criteria, such as, for example, the type of file, the date/time the file was created, keywords associated with the file, etc.

The interface 108 may further include a history window 120B. A magnified view of the history window 120B is provided in FIG. 2B. The history window 120B may provide geospatial and temporal information for content presented during the VMR session, as well as levels of participant participation during the VMR session, by providing information regarding, for example, the names of files, documents, etc. that were presented in the canvas 116 during the VMR session, along with the respective number of times each content item was presented, as well as an indication of the duration for which each content item remained on display in the canvas 116. In some implementations, a scale S and bars T of varying lengths corresponding to time stamps may be positioned relative to the scale S such that a visual representation of when and for how long content 118 (e.g., files A-C) is provided. Although in this example the history window is shown during the VMR session, in other implementations the history window 120B may be presented after the VMR session has been completed in order to provide the organizers and participants with an outline of what was discussed during the session and a view of the level of involvement of each participant.

The interface 108 may further include toolbar 122 for the intended purpose of enhancing the content 118 while on display in the presenter collaboration canvas 116. The toolbar 122 may include one or more input components (e.g., color pallet, geometric shapes, font size adjustment menu, radio “Save” buttons, etc.) Each one of the input components may be associated with one or more selectable tools 124 for annotating and/or marking content 118 presented in the presenter collaboration canvas 116 during the VMR session. The tools 124 may facilitate a variety of functions, for example: image highlighting, text insertion, freehand sketches, adding geometric figures, and/or other markings to the image files that are presented as content 118. The content 118 may be marked up (e.g., annotated, marked, highlighted, etc.) when displayed in the presenter collaboration canvas 116. In another incidence, the content 118 may be marked up (e.g., annotated, marked, highlighted, etc.) when displayed in a VMR session participant's private display window.

Pant-Tilt-Zoom (PTZ) Control may also be provided as a separate tool within the user interface 108 for controlling the state of any IP camera (with incorporated PTZ control functionality) configured as an External Data Provider 102 to the VMR session. For example, the tool may permit panning, tilting, and zooming of each of the cameras and/or IP video steaming devices configured as part of the VMR session from any location and by a participant with the properly-assigned privileges.

In some aspects, metadata may be collected (e.g., digital breadcrumbs that are generated by the user interface 108 over the course of a VMR session) that indicates how the participant interacts with the user interface 108 during the session. For example, the metadata may identify activities performed by the user during the VMR session including, for example, chatting, responding to polling questions, uploading/downloading files, marking up content, etc. The metadata may be uploaded to the VMR's respective clip bin(s) and may be made accessible to participants (e.g., corporate trainees or students) at the time of the VMR session and/or anytime thereafter.

In some aspects, the collection of such metadata may facilitate performance measurement and/or learning analytics, and may allow instructors, management, and/or administrative staff to examine correlations between online learning activities and increased knowledge or performance. Such performance measurement or learning analytics may facilitate timely interventions for those employees and/or students that are at greatest risk, as well as, to aggregate data to evaluate whether changes in curriculum are necessary.

During both synchronous and asynchronous VMR events, participants may create a condensed or edited version of the streams. A participant may also pause, stop, and/or re-start the asynchronous presentation. During a live session, the participant may activate the Instant Replay tool to create a video clip/segment associated with the video streaming in the Video Player window 114. The participants may restrict access to the content they have created such that the content may be viewable to select participants, e.g., to the creator of the content, to some participants, or to all of the participants.

The participant's Private Work Area (PWA) section of the User Interface 108 may provide one or more session-related “activity” modules 128a-d that facilitates communication and sharing between the VMR session moderator and each of the participants, while also providing self-help functionality for each individual participant. For example, the PWA box 128 may include a first module 128a that displays a series of video stream channels, each of which can be selected for viewing in the video player window 114. This plurality of video streams (e.g., the video stream of a presenter or speaker, or of the stream of an aerial view video captured from a surveillance camera mounted to a surveillance aircraft or drone) may be available during a VMR session and selectable for viewing either by the participant directly or by the session moderator/instructor. Participants may also share video streams (e.g., pre-recorded video or live video of, for example, the participant's personal web-cameras) via a second module 128b, which the participant may select to cast or stream to the other participants.

A message broadcast/Chat module 128c may facilitate text communication between two or more participants. For example, the message broadcast/chat module 128c may include an area or space in which a word or phrase or other content (e.g., emoticons and the like) may be input and then broadcast as a message to one or more selected participants or to all of the participants. After inputting a message into the message broadcast/chat module 128c, the participant may confirm by selecting an option to broadcast the message thereby transmitting the message to the other participants, which may be displayed to the other participants as an alert or pop-up message. The chat component of 128c may be provided to allow participants to input chat data or messages (e.g., text messages, audio recordings or video recordings) and to send the chat data to the entire group of participants, to a select group of individual participants or to a single participant of the meeting.

In addition to the other three PWA modules, there may be a Session Participant Polling module 128d that permits the VMR session moderator to initiate a comparison (true/false or yes/no), a multiple choice or short answer question and answer activities, opinions and feedback activities, and the like. All such activities may be recorded and/or correlated in an analytic engine where the resulting responses can be viewed both temporally and geographically in a table or the like such as within the History window 120B.

Finally, the PWA 128 may include a digital note pad module 128e for the purpose of allowing VMR session participants to track and document pertinent activities throughout the session in their own words and style and then save this text file to their personal session bin for future reference and review.

FIG. 3 is a flowchart of an example of a process 200 for conducting a VMR session, according to aspects of the disclosure. As used throughout the disclosure, the term “Virtual Meeting Room (VMR) session” refers broadly to any suitable type of communication session in which some type of content (e.g., audio content, visual content, or audiovisual content) is exchanged between any two or more of the client devices and/or any of the client devices 106 and the CMS 104. For example, the term “Virtual Meeting Room (VMR) session” may refer to any suitable type of communications session, such as a video call, an audio call, an online lecture, a virtual meeting, and/or combination thereof.

At task 210, a virtual collaboration environment for the VMR session is defined. Task 210 is discussed in further detail with respect to FIG. 4.

At task 220, the VMR session is conducted by using the virtual collaboration environment. Task 220 is discussed in further detail with respect to FIG. 5.

At task 230, the VMR session is concluded. When the VMR session is concluded, all streams that are presented during the VMR session and content items inserted into the VMR session's respective clip bin may be archived in CMS 104 for later search, retrieval, and analysis. In addition, a full-session record can be used to capture all elements of the session (i.e., a video stream, the content of a collaboration canvas, etc.). In some implementations, a condensed version may be created of a video stream presented during the VMR session. For example, the video stream may be one that is presented in the video player window 114. The condensed version of the video stream may include highlights from the video stream, and may be created by using video-editing tools that are made available with the interface for conducting the VMR session. The condensed version may also be archived by the CMS 104.

At task 240, activities that occurred during the VMR session may be catalogued and/or archived, and the user may be presented with one or more history records of the VMR session. In some implementations, each participant's online activities may be graphically represented in a timeline to show what has been captured and annotated. Additionally, or alternatively, the condensed version of the media stream may be displayed. Additionally, or alternatively, the full-session record stored at task 230 may be used to render various events that took place during the VMR session in sequence. The playback may be effectuated based on timestamps associated with the display of images in a participant's collaboration canvas, the input of annotations of the users, and/or various other actions performed by the participant.

FIG. 4 is a flowchart of an example of a sub-process or task 210 for defining a virtual collaboration environment of the process 200 for conducting a VMR session. In particular, task 210 may include a step in which the CMS 104 may receive an instruction to schedule a VMR session. In some implementations, the instruction may identify a preferred time or time range for the conference, an identification of one or more presenters, an identification of a characteristic sought in at least one presenter (e.g., expertise in a particular subject), a location where the presenter needs to be present, a number of participants expected to be present, etc. The instruction may be submitted by a user, herein referred to as “initiator.”

At task 212, in response to the instruction, the CMS 104 identifies one or more presenter profiles that satisfy a first predetermined criterion. In some implementations, the criterion may be determined by the CMS 104 based on information received along with the instruction to schedule the conference. Additionally, or alternatively, in some implementations the criterion may be specified by the initiator. For instance, the CMS 104 may identify one or more profiles of presenters who have an expertise in a subject matter specified by the initiator.

At task 213, the CMS 104 may identify one or more room profiles that satisfy a second predetermined criterion. By way of example, the term “room” may refer to either a physical location (e.g., a broadcasting location) where a presenter is required to be present or a virtual room. The physical locations may include suitable hardware as required by the system including, for example, computing equipment, video cameras, microphones, etc. By way of example, the second criterion may be determined based on information submitted with instruction to schedule the VMR session or specified separately by the initiator. For example, the CMS 104 may identify one or more rooms that are available at a time desired by the initiator. Additionally, or alternatively the CMS 104 may identify one or more rooms that have a desired seating capacity or location. Additionally, or alternatively, the CMS 104 may identify one or more rooms that have a desired bandwidth, and or other computing resources necessary for conducting a VMR session (e.g., computing resources needed to support a given number of session participants and/or computing resources needed to support the manipulation and/or exchange of a given type of content between the session participants.

At task 214, the CMS 104 selects a combination of a room and presenter (and/or other participants) for the VMR session. In some implementations, the CMS 104 may provide the initiator with a list of available participants and/or available rooms that were identified at tasks 212, 213. Afterwards, the CMS 104 may receive from the initiator a selection of one of the rooms and/or participants and schedule the conference accordingly. Alternatively, in some implementations, the CMS 104 may identify presenter-room pairs based on the availability of the presenter(s) the room(s), and provide the initiator with a list of the identified pairs. Subsequently, the CMS 104 may receive a selection from the initiator of one of the pairs, and schedule the VMR session accordingly. In some implementations, scheduling the session (e.g., teleconference) may include one or more of scheduling calendar appoints for the participant, and or making reservations for the room and/or other resources needed to conduct the VMR session.

At task 215, the initiator selects a clip bin for the VMR session. The clip bin may include a storage location that is dedicated to storing various types of data items related to the VMR session. The clip bin may be implemented by using one or more relational database(s), a file server, cloud storage, and/or any other suitable mechanism for storing data. In some implementations, the data stored in the clip bin may be available to all participants in the VMR session. Additionally, or alternatively, in some implementations, the CMS 104 may enforce access restrictions on the data stored in the clip bin. For example, the CMS 104 may grant or deny access to a given content item in the clip bin to a user based on a permission record associated with the content item that specifies which users and/or user groups are to have access to that content item.

At task 216, the CMS 104 stores data in the clip bin that is uploaded by the initiator and/or session participant. The data may include any suitable type of data (e.g., document file(s), video file(s), image(s), audio file(s), etc.), which the initiator expects to be used during the VMR session. During instances in which the clip bin is implemented using a relational database, storing the data in the clip bin may include associating the data with a Session ID for the VMR session. Additionally, or alternatively, in instances in which the clip bin is implemented using a file server, storing the data in the clip bin may include uploading the data to a particular file system directory that is associated with the Session ID for the VMR session.

FIG. 5 is a flowchart of a sub-process or task 220 of the process 200 for conducting a VMR session according to aspects of the disclosure. As shown in FIG. 5, task 220 may include various steps or tasks. At task 221, one or more participants may log into a room allocated for the VMR session. When the participants are logged into the room, their client devices may display the user interface 108 for conducting the VMR session. At task 222, the client device 106 of one of the participants receives input to the interface 108. At task 223, the client device performs an operation based on the input. And at task 224, the client device transmits an indication of the operation to the CMS 104.

For example, at the onset of the VMR session, the initiator and/or other participants having sufficient privileges may determine what media stream is going to be shown in the video player window of the VMR session recipients. For example, the initiator may select one of multiple available media streams for presentation in the video player window. Afterwards, the client device of the initiator may transmit an indication of this stream to the CMS 104. Upon receiving the indication, the CMS 104 may isolate the stream, which is then fed to the client devices of the participants for display in the participants' respective video player windows. In some implementations where multiple streams are available for viewing by the VMR session participants, the CMS 104 will make each stream available to the participants' client devices. Additionally, or alternatively, one or more of the streams may be received at the CMS 104 from external data sources.

In some implementations, the initiator and/or other participants having sufficient privileges may generate a live map view. These privileges may permit the display of several map layers, which can further be presented to the VMR session participants in the presenter collaboration canvas 116.

Alternatively, at the onset of the VMR session, the initiator and/or other participants having sufficient privileges may select a multi-page file stored in the VMR session's respective clip bin for presentation in the presenter collaboration canvas and transmit an identification of this unique file type to CMS 104. Afterwards, the CMS 104 may generate a sequence of content items based on the selected file, as discussed above, and present each individual .PNG file in the sequence requested by the initiator to each of the participant's respective collaboration canvases.

In another example, the VMR session initiator (or another participant who has sufficient privileges) may “share” a single image or video file (e.g., a text file, a digital photograph, an MP4 video file, etc.) that is shown in the clip bin viewer 126 with all session participants using the presenter collaboration canvas 116. In response to this input, the user interface 108 (or the device displaying it) may transmit to the CMS 104 an instruction to execute a display command of the selected file for presentation in the collaboration canvas 116. The instruction may include any indication of the file that the participant wants displayed and/or an indication of a particular portion of the file (e.g., a page number) that the user wants to be displayed.

As another example, a participant (with control of the presenter canvas) in the VMR session may annotate a given image (or another type of static content item) that is shown in the presenter collaboration canvas 116. For example, the participant may select a highlighting tool from the toolbar 122 and highlight text in the image.

As another example, the user may select a drawing tool from the toolbar 122 and add a drawing to the image. As another example, the user may select a text tool from the toolbar 122 and add text to the image. On each occasion that an image is modified with an annotation of any kind, these markings are immediately (and automatically) transmitted to the presenter collaboration canvas of each participant in the VMR session through the CMS 104. Also when the image is annotated, the user interface 108 (or the device displaying it) may transmit to the CMS 104 an instruction to store the annotations in the VMR session's on the image that is current stored in the respective clip bin. The instruction may include any suitable type of message that includes an indication of the annotation and is used by the CMS 104 to store the annotation in the participants' respective clip bins and/or disseminate that annotation among other teleconference participants. The indication of the annotation may include the annotation itself, a pointer to an address (e.g. on the client device or in the clip bin) from where the annotation may be retrieved by the CMS 104, etc. In this implementation, the instruction to annotate may be automatically transmitted in response to the user input creating the annotation (e.g., a drag of a highlighting tool across text, etc.). Thus, the image shown in the collaboration canvas 116 can be both annotated and disseminates in response to the same input.

In response to the instruction, the CMS 104 may modify a content item stored in the clip bin that is represented by the annotated image to include the annotations. Additionally, or alternatively, in response to the instruction, the CMS 104 may update the content 118 that is presented in the participants' respective collaboration canvases to include the annotations. As noted above, updating the content 118 may include transmitting an indication of the annotations to the other client devices that participate in the VMR session and/or updating a data structure that is used by the CMS 104 in generating the content 118.

In another example, a participant in the VMR session may capture and create an image file of one or more frames of video content that is displayed in the video player window 114. The participant may then annotate the recorded frames and transmit the recorded frames for storage in the clip bin associated with the VMR session in order for the captured frame(s) to be shared with one or more other participants in the session.

In another example, a participant in the session may elect to replay a segment of the media stream that is being presented in the video player window 114. Replaying a segment of the media stream may cause the canvas 114 to display a series of still frames or images. Afterwards, the still frame or image may be displayed, and the participant may annotate the still frame as discussed and transmit an instruction to the CMS 104 to disseminate the still frame along with the annotation among the other participants in the session. In response to receiving the instruction, the CMS 104 may add the still frame to the content 118 for presentation in the canvas 116. As discussed above, the annotation and the transmission of the instruction to disseminate the annotation may be performed in response to an annotating input (e.g., an input in which the participant drags a highlighting tool or a drawing tool over the still image).

Referring to FIG. 6, a schematic diagram of a system 600 is shown that includes a data provider 602, a content management system (CMS) 604, and client devices 606, 608 and 610.

The data provider 602 may include any suitable type of device that is arranged to transmit data to CMS 604 (in advance of or during a VMR session) for presentation during the VMR session. The data provider 602 may include a map server (e.g., a GOOGLE MAPS or ESRI server), a streaming media server (e.g., a streaming video server, a streaming audio server), one or more Internet Protocol (IP) cameras, and/or any other suitable type of data transmitting device. In some implementations, the data provider 602 may be part of a device, such as the IP camera on a drone or autonomous vehicle, that is operating in the field to collect data in real-time while the VMR session is taking place.

The CMS 604 may include one or more database servers, a streaming media server, a file server, and/or any other suitable type of device that is configured to bring virtual collaboration capability to the client devices 606-610. The CMS 604 provides a collaborative environment that may link data, graphics, streaming video, and other digital sources into a private cloud to facilitate presentations, work sharing, research, and other learning activities among participants in geographically disparate locations such that they can participate in a single event or meeting or session. By way of example, the CMS 604 may provide some or all of a rich-media presentation platform; live and recorded video streaming; lecture and/event capture services; virtual collaboration and/or social learning sessions; performance measurement analytics; enterprise-grade security for computers and mobile devices; premier content management; and/or centralized event scheduling. It is to be understood that the CMS 604 may include a single server or a plurality of servers (or other devices) distributed across multiple locations and technology platforms.

As illustrated, the CMS 604 may include, for example, a processor(s) 604a, a memory 604b, and/or a communication interface 604c (e.g., 4G, LAN, etc.) or any suitable hardware architecture that can be used to implement any of the client devices 606-610 and/or any server or device that is part of the CMS 604. The CMS 604 may include any suitable type of processing circuitry, such as one or more of a general-purpose processor (e.g., an ARM-based processor or an AMD64-based processor), a Field Programmable Gate Array (FPGA), an Application Specific Integrated Circuit (ASIC), or a Digital Signal Processor (DSP). The memory 604b may include any suitable type of volatile or non-volatile storage. For example, the memory 604b may include a Random Access Memory (RAM), a hard drive (HD), a solid state drive (SSD), a cloud-based storage, a remote storage, or a Network-Accessible Storage (NAS).

The clip bin manager 604b-1 may include processor-executable instructions that are arranged to manage and operate a clip bin for a particular VMR session. The task management system 604b-2 may include processor-executable instructions may that are arranged to manage a task management system. The task management system may be accessed from within virtual meeting rooms, and it may serve as the core technology for the introduction and use of a comprehensive enterprise project management solution. The task management system 604b-2 may include a database for storing project records, task records and/or other information. Although in the present example the task management system is integrated into the CMS 604, in some implementations the task management system 604b-2 may be implemented by using a separate server or a collection of servers.

The task management system permits the participants in any given VMR session to go to one place to manage all of their projects. In some aspects, the task management system may permit the creation of new tasks and the association of any one of the tasks with pre-existing or newly created projects. Each task may be represented by a respective task record. The task record may contain various types of information regarding the task that permit users to assess the task's status and place within a project. For example, a given task record may identify a due date and a priority level for a task, as well as personnel that is designated to perform or monitor the task. Furthermore, the given task record may include a list of actions taken with respect to the task, release notes, comments, question answers, and suggestions. In some implementations, the task management system may be arranged to generate task reports which identify the progress of various tasks within a project.

The communications interface 604c may include any suitable type of wired or wireless communication interface, such as an Ethernet interface, a 4G interface, or a WiFi interface. The client devices 606, 608, and 610 may include any suitable type of electronic device capable of interacting with the CMS 604 and participate in one or more VMR session(s) that are being managed using the CMS 604. For example, any of the client devices 606-610 may include one or more of a desktop computer, a laptop, a tablet or a smartphone. According to aspects of the disclosure, at least one of the data provider 602 and the client device 606, 608, and 610 may be connected to CMS 604 via any suitable type of communications, such as, for example, the Internet, a Wi-Fi network, a LAN, a WAN, a 4G network, etc.

FIG. 7 is a diagram of an example a user interface 708 for participating in a Virtual Meeting Room (VMR) session that is conducted by using the CMS 604. The user interface 708 may be either browser-based or a standalone application, such as an iOS/Android Application (App), that can be executed without the need for a web-browser. In instances in which the interface is browser-based, the user interface 708 may be provided by the CMS 604 to the client device 606 upon logging to the CMS 604, after which the user interface 708 may be displayed in a web browser (e.g., Internet Explorer, Firefox, Chrome, Safari, etc.). In the present example, the user interface 708 is executed on the client device 606, but it can be executed on any client device that participates in the VMR session.

As illustrated, the user interface 708 may include the status bar 112, the video player window (VPW)114, the clip bin viewer 126, and the presentation canvas 116, which are discussed above with respect to FIG. 1-5. Furthermore, the user interface 708 may further include a track interface 710, a carousel 720, a private work area (PWA) 730, and a toolbar 740.

The track interface 710 may include radio buttons (i.e., option buttons) for selecting the operational mode of a tracker, and a track button 710a for activating the tracker. In the present example, the tracker is arranged to operate in one of a manual mode and an automatic mode. Although in the present example the operational mode of the tracker is selected via radio buttons that are concurrently displayed with the track button 710a, the VPW 114, and the presentation canvas 116, it is to be understood that the operational mode of the tracker may be selected in any suitable manner and/or by using any suitable type of input component.

When the track button 710a is pressed, the client device 606 may activate a tracker for marking content that appears in a video presented in the VPW 114. The tracker may include one or more processor-executable instructions that are executed by at least one processor of the client device 606. As is discussed further below, in some implementations, the tracker may be an overlay tool that utilizes the movement and placement of a cursor (e.g., via a computer mouse) on the VPW 114 to position and display one of a set of custom “symbols” on one or more frames of interest from the video.

More particularly, the tracker may mark the location of a selected object of interest in different frames of the video. For example, the tracker may display every 15^{th} frame of the video in the presentation canvas 116 and superimpose a symbol over the frame at (or adjacently to) the location of the object of interest in the frame. In this manner, in instances which the video is received from an unmanned aerial vehicle or another surveillance device, actionable intelligence can be instantly shared with VMR session participants associated with a surveillance event at every fixed or mobile location.

As illustrated in FIG. 8, after the track button 710a is pressed, a user may place a mouse cursor 811 over a first location in the presentation canvas. In response to this input, the tracker may retrieve a frame from the video (e.g., the frame that is currently displayed in the VPW 114), select a second location in the frame based on the first location, and display the frame in the presentation canvas 116 along with an overlay item (e.g., the marker 810) that is superimposed on the frame at the second location. The second location may be the same or different (e.g., offset) from the first location. The tracker may repeat these steps continuously while the video is playing in the VPW 114 and/or while the mouse cursor 811 remains placed on the VPW 114.

When the tracker is in the automatic mode, the tracker may automatically refresh the presentation canvas 116. More particularly, the tracker may repeatedly (e.g., periodically) detect a first location of a mouse cursor in the VPW 114 (e.g., the current location of the mouse cursor), retrieve a frame from the video (e.g., the frame that is currently displayed in the VPW 114), identify a second location in the frame based on the first location, display the frame in the presentation canvas 116 along with an overlay item that is superimposed on the frame at the second location. The second location may be the same or different (e.g., offset) from the first location. The tracker may repeat these steps continuously while the video is playing in the VPW 114 and/or while the mouse cursor 811 remains placed on the VPW. In some implementations, the tracker may refresh the presentation canvas 116, at a rate that is lower than the video's frame rate. For example, the tracker may refresh the presentation canvas every 0.5 seconds while the video plays at 30 or 60 frames per second. In such instances, the tracker may display every 15^{th} frame from the video in the presentation canvas 116. Stated succinctly, the presentation canvas 116 and the VPW 114 may be refreshed at different frame rates, such that the video is displayed in full motion mode in the VPW 114, while also being displayed in frame-by-frame mode in the presentation canvas 116.

When the tracker is in the manual mode, the presentation canvas may be refreshed only when the user presses a predetermined button (e.g., a mouse button) or provides further input in addition to the selection of a particular location in the VPW 114. For example, when the user places the mouse cursor over the VPW 114 and presses the mouse button, the client device may detect a first location of the mouse click, retrieve a frame from the video (e.g., the frame that is currently displayed in the VPW 114), identify a second location in the frame based on the first location, display the frame in the presentation canvas 116 along with an overlay item that is superimposed on the frame at the second location. The second location may be the same or different (e.g., offset) from the first location. In some aspects, the manual mode of the tracker may differ from the automatic mode in that in the manual mode, the user has to click the mouse every time he or she wants the presentation canvas refreshed, whereas in the automatic mode the user does not need to provide additional input after placing the mouse cursor in the presentation canvas in order for the presentation canvas 116 to be refreshed.

In some implementations, as illustrated in FIG. 8, the marker 810 may be an overlay item that is used to mark the location of the selected object. The marker 810 may include one or more of an image, text, a number, and/or any other suitable type of content. The marker 810 may either automatically selected or custom-selected based on user input. For example, the marker 810 may be selected by using a menu that is similar to the symbol overlay menu shown in FIG. 11. Although in the present example only one object is being tracked, it is to be understood that any suitable number of objects may be tracked instead (e.g., two, three, five, ten, etc.).

In some implementations, the tracker may synchronously refresh the respective presentation canvases of all participants in the VMR session, so that each participant sees the same annotated image in their respective presentation canvas. Although in the present example the tracker is executed by the CMS 604, in some implementations, the tracker may be executed by the client device 606, and/or another device. Furthermore, in some implementations, the tracker may be executed in a distributed fashion by the CMS 604 and the client device 606.

Although in the present example the track button 710a is used to transition the electronic device into tracking mode, any other suitable type of input component may be used instead. Furthermore, although in the present example the track button 710a is displayed on the same screen as the VPW 114 and the presentation canvas 116, the track button 710a may be presented on a different screen. And still furthermore, in some implementations, the track button 710a may be altogether omitted from the user interface 708. In such instances, the tracker may be activated in response to the client device 606 detecting an input that selects a particular location in the VPW 114.

Although in the present example, the tracker displays an overlay item (e.g., the marker 810) in the presentation canvas 116, when a first location is selected in the VPW 114, in some implementations the overlay item may be displayed in the VPW 114 instead.

Although in the present example, the tracker functions as a virtual “laser pointer” which permits the user to highlight portions of video content by placing a mouse cursor on the portions, in some implementations the tracker may use image recognition to track specific objects that appear in the video. In such instances, after the track button 710 is pressed, a user input may be received that selects a particular object in the video, such as a lecturer's face. In response to the input, the object tracker may retrieve a frame from the video, process the frame by using an image recognition technique to automatically identify the location of the selected object, and display the frame in the presentation canvas 116 along with an overlay item that is superimposed on the identified object. The object tracker may repeat these steps continuously while the video is playing in the VPW 114 and/or while the selected object appears in the video.

The carousel 720 may provide access to screenshots of the presentation canvas that have been saved during the VMR session. In addition, the carousel 720 may enable the user to create a temporary storage location (e.g., a temporary clip bin, a temporary folder, etc.) for storing screenshots of the presentation canvas which can then become the elements of a generated document file (e.g., a PDF file). Each screenshot may include a base item (e.g., an image, text, or another type of content) that is displayed in the presentation canvas during the VMR session and/or annotations that have been made to the base item. In some aspects, saving the screenshots and generating a document that includes the screenshots may permit participants in the VMR session to view later content that was presented during the session.

The carousel 720 may include a content list 722 and a toolbar 724. The content list 722 may include a plurality of icons, each of which may correspond to a different screenshot. The content list 722 may be scrolled up and down using the buttons 722a and 722b. Icons in the content list 722 may be selectable (e.g., via a mouse click or a touch). When a particular icon is selected, that icon may be highlighted by superimposing a marker 722c on it or in any other suitable manner.

To change the order of the icons in the content list 722, the user of the client device 606 may use the buttons 724a and 724b, respectively. For example, when the button 724a is pressed, the client device 606 may move a selected icon (e.g., the second icon from the top down) up the list. As another example, when the button 724b is pressed, the client device 606 may move the selected icon down the list.

To remove an icon from the list, the user of the client device 606 may press the delete button 724c. For example, when the delete button 724c is pressed, the client device 606 may remove the selected icon from the list and/or delete the selected icon's respective screenshot.

Any time up to and including the end of the session, the document button 724d presents the user with the option to create a single document file including screenshots that are represented in the carousel. A screenshot may be represented in the carousel, if the content list 722 includes an icon corresponding to the screenshot.

In some implementations, the document file may include all of the screenshots that are represented in the content list 722. In such instances, the user may utilize the delete button 724c to choose which screenshots are to be included in the document and the buttons 724a and 724b to specify the order in which the screenshots are to be arranged in the document. Additionally, or alternatively, in some implementations, the document may include only screenshots that are specifically selected by the user for inclusion in the document (e.g., via a mouse click or a touch) at the time when the document button 724d is pressed.

More particularly, when the document button 724d is pressed, the client device may generate and save a document file (e.g., PDF file) including the screenshots that are represented in the content list 722. The document file may be saved in the clip bin associated with the VMR session, at a storage location on the client device 606, and/or any other suitable location. In some implementations, each page in the document file may include (or otherwise be based on) a different one of the screenshots represented in the content list 722. Furthermore, in some implementations, the pages in the document may be arranged in the order in which the pages' respective screenshots are represented in the content list 722.

Although in the present example documents are represented in the content list 722 by icons, it is to be understood that in some implementations any of the screenshots may be represented by a text string, a number, and/or any other suitable type of identifier. In some implementations, the screenshots represented in the content list 722 may be generated automatically when a new base item (e.g., an image) is displayed in the presentation canvas. Additionally, or alternatively, the screenshots represented in the content list may be saved in response to a particular input component being activated. For example, the screenshots may be generated when the save button 746 is pressed by the user.

The private work area (PWA) 730 of the user interface 708 may provide one or more session-related “activity” modules that facilitate communication and sharing between the participants in the VMR session. In the present example, the PWA 730 may provide access to a quiz/polling module and a task management module, which are accessible via the button 732 and the new task button 734, respectively. Each of these modules may include processor-executable instructions that cause the client device 606 to display the user interfaces discussed with respect to FIGS. 9-10B. Any of the modules may be at least partially executed by the client device 606 and/or the CMS 604. Furthermore, in some implementations, any of the modules may be executed in a distributed fashion by the client device 606 and the CMS 604.

When the button 732 is pressed, the client device 606 may display a participant quiz interface 910, an example of which is depicted in FIG. 9. As illustrated, the participant quiz interface 910 may include a drop-down list 912 for selecting the type of the question that is being generated, and a question field 914 in which the user can type in the question. After the user has selected the question type and entered the question, the user may press the post button 916. The client device 606 may then detect that the post button 916 is pressed, and transmit the question, as well as a response interface to the CMS 604. Upon receiving the question and response interface, the CMS 604 may disseminate the question and the response interface among the other participants in the VMR session, and collect their responses.

The response interface may include a data structure (e.g., a markup language file) and/or any other suitable type of data representation, which when rendered/executed by a client device causes the client device to display a menu for answering the question. For example, if the question is a multiple choice question, the menu may include a plurality of radio buttons for choosing multiple choice answers. As another example, if the question is an essay question, the menu may include a text input field where the VMR session participants may type in the answer.

After the question and the response interface are disseminated among the other participants in the VMR session, the CMS 604 may aggregate the participants' responses to create analytics regarding the quality of student performance or content delivery, for example. Although in the present example the carousel 720 is displayed in the same window as the presentation canvas 116 and the VPW 114, in some implementations the carousel 720 may be displayed in a separate window. By way of example, the carousel 720 may be displayed a pop-up window that includes only the carousel, or in a separate screen that is accessible via a tab or a ribbon interface.

In the example of FIG. 9, the participant quiz interface 910 may be a menu that is superimposed on portions of the user interface 708 while the VMR session is being conducted. However, in some implementations, the participant quiz interface 910 may be displayed in a separate pop-up window. Furthermore, according to the present example, the drop-down list 912 may permit the user to select a multiple-choice type, a comparison type, and short answer type of the question, but the disclosure is not limited to any particular set of question types. And still furthermore, although in the present example, the participant quiz interface 910 includes a drop-down list and a text input field, it is to be understood that in some implementations the participant quiz interface 910 may include any suitable number and type of input components that can be used to specify the question and/or question type.

When the new task button 734 is pressed, the client device 606 may activate the task management module. The task management module may cause the client device 606 to display a task management interface (TMI) 1000 for accessing the capabilities of the task management system 604b-2. The TMI 1000 may provide a comprehensive enterprise project management solution that is integrated with the user interface 708 and may permit the immediate association of new tasks with a preexisting or newly created project. The integration of the TMI 1000 into the user interface 708 may contribute to a greater span of control over projects, a reduction in face-to-face meeting time with individuals and team members, enhanced communications between the team members, and increased organizational productivity.

The TMI 1000 may be displayed while the VMR session is being conducted. As illustrated in FIGS. 10A-B, the TMI 1000 may include a task details tab 1010 and a task owner tab 1050 which can be used to create a new task, and add it to a new or existing project. More particularly, the task details tab 1010 may include a task number field 1012 for specifying an ID for the new task, a tier field 1014 for specifying the tasks' project category, a product field 1016 for identifying a sub-category associated with the task, a priority field 1018 for specifying a priority of the new task, and date fields 1020 and 1022 for identifying the date on which the new task is created and the completion deadline for the task, respectively. Furthermore, the task details tab 1010 may include a description field 1024 in which the user may type a brief description of the task.

The requirements portion 1026 may be used to specify detail about the work items that need to be performed in order for the task to be considered completed. The requirements portion may include an input field 1028 and attach button 1030. In the input field 1028, the user may type in a particular requirement for the task, while the attach button 1030 may be used to attach one or more files that are associated with the particular requirement. The attached files may include image files, document files, and/or any other suitable type of file. When a record for the new task is created, the attached files may be stored in the task management system 604b-2 along with the record.

When the attach button 1030 is pressed, a file browser window may be displayed. The file browser window may permit the user to browse the contents of the clip bin associated with the VMR session and select one or more image files from the clip bin for inclusion into the task record. In such instances, the clip bin for the communications session may be set as the root of the file browser. Furthermore, in some implementations, one or more files may be automatically associated with the requirements for the new task. For example, an image file that is currently presented in the presentation canvas 116 when the new task button 734 is pressed may be automatically attached to the task requirements. Additionally, or alternatively, in some implementations, a screenshot of the presentation canvas 116 may be automatically generated and attached to the task requirements when the new task button 734 is pressed. The screenshot may include the image file and all annotations that have been made to the image file in the presentation canvas 116 prior to the new task button 734 being pressed.

The add requirements button 1032 may be used to add further requirements to the task record. When the add requirements button 1032 is pressed, a new requirement input field may be displayed in the requirements portion 1026 along with a new attach image button. In some aspects, the ability to specify multiple/additional task requirements via the requirements portions 1026 may provide greater task granularity.

The task owner list 1034 may be a drop-down list and/or any other suitable type of input component that can be used to specify an owner of each new task created. In some implementations, the task owner list 1034 may be automatically populated with the names of at least some of the participants (and/or other identifiers, such as emails or employee IDs that belong to the participants) in the VMR session, thereby permitting the user to assign ownership of the new task conveniently. The QA Person field 1036 may be a drop-down list and/or any other suitable type of input component that can be used to specify a Quality Assurance (QA) person for the new task. In some implementations, the QA field 1036 may be automatically populated with the names of at least some of the participants in the VMR session, thereby permitting the user to assign ownership of the new task conveniently.

The “TO:” field 1038 and “CC:” field 1040 may include the names (or emails) of persons that are to be notified of the creation of the new task. Once the new task is created, the task management system 604b-2 may transmit to each of the individuals identified in the TO and CC fields a message indicating that the new task is created. Any of the TO field 1038 and the CC field 1040 may include a text input field, a drop-down list, and/or any other suitable type of input component.

The task owner tab 1050 may include task description fields 1052 and 1054 in which the user may type further information regarding the task. In addition, the task owner tab 1050 may include a date field 1056 for identifying the date on which the task was completed, a status field 1058 for identifying the status of the new task, and a submit button 1060. As can be readily appreciated, the date field 1056 may be left blank when the new task is created and filled in later. When the submit button 1060 is pressed, the client device may transmit all of the information that is input into the TMI 1000 to the CMS 604 along with an instruction to create a new task record based on the information. In response to the instruction, the CMS 604 may create a new record corresponding to the new task and store the new record in the task management system 604b-2.

Stated succinctly, the task management module and the task management system 604b-2 may present the user of the client device 606 with the capability to create a new task on the spot while the VMR session is being conducted. More particularly, the task management module and the task management system 604b-2 may permit the user to specify a due date and priority level for the task (e.g., via the fields 1018 and 1020) and enter one or many requirements for the task in order to provide task granularity. Furthermore, the task management module and the task management system may automatically designate information regarding the task (e.g., description, requirements, etc.) to designated personnel, such as the personnel specified in the fields 1034-1040. And still furthermore, the task management module and the task management system may apply task updates, and disseminate latest status, record actions taken with respect to the task and release notes, enter comments and suggestions, and generate task reports.

The toolbar 740 may provide access to various capabilities for accessing and manipulating content displayed in the presentation canvas 116. As illustrated in FIG. 7, these capabilities can be accessed via a zoom-out button 742, a zoom-in button 744, a save button 746, a shape overlay button 748, a symbol overlay button 750, and a new overlay button 754, respectively.

When the zoom-out button 742 is pressed, the client device 606 may zoom out on the content shown in the presentation canvas 116. Similarly, when the zoom-in button 744 is pressed, the client device 606 may zoom-in on the content shown in the presentation canvas. Even though in the present example, the zoom-in and zoom-out buttons are being used, in some implementations these buttons may be omitted from the user interface 708. In such instances, the image displayed in the presentation canvas may be zoomed-in and/or zoomed-out by turning the scroll wheel of a mouse, by performing a pinch gesture on the presentation canvas 116 with his or her hands, and/or in any other suitable manner.

The save button 746 may enable the user to save content that is currently displayed in the presentation canvas 116. When the save button 746 is pressed, the client device 606 (and/or the CMS 604) may generate and save a screenshot of the presentation canvas. The screenshot may include at least one of a base item (e.g., an image) that is shown in the presentation canvas and annotations that have been made to the base item. The screenshot may be saved in any suitable image format (e.g., .jpg or .png).

In some implementations, the presentation canvas 116 may allow images, and/or other content displayed therein, to be moved from left-to-right, up-and-down, and/or diagonally through the use of an image dragging tool that is built into the user interface 708. Thus, when the client device 606 detects that a dragging input is performed in the presentation canvas, it may change the position of a base item that is displayed there (and/or annotations made to the base item) within the presentation canvas. For example, if an upward drag input is performed in the presentation canvas 116, the client device may move upwards all content that is displayed in the presentation canvas.

The shape overlay button 748, the symbol overlay button 750, and the new overlay button 754 may provide users with the ability to annotate the presentation canvas with custom symbols/shapes, as well as predetermined symbols and shapes. The availability of the buttons 748, 750, and 754 may enable the user of the client device 606 to annotate the presentation canvas 116 with complex content, such as math equations and/or chemical formulae. Furthermore, the availability of the custom overlay items can save time and ensure accuracy during a live VMR session.

When the shape overlay button 748 is pressed, the client device 606 may display a shape overlay menu 1110, as shown in FIG. 11. The user may then select one of the shapes in the shape overlay menu and a location in the presentation canvas 116 where the user wants the selected shape to be placed. Afterwards, the client device 606 may display the selected shape at the selected location. The selected shape may be superimposed over any image or other content that is already being displayed in the presentation canvas 116.

Similarly, when the symbol overlay button 750 is pressed, the client device may display a menu including one or more special characters (e.g., a mathematical equation or chemical formula). The user may select any one of the symbols in the menu along with a location in the presentation canvas 116 where the user wants the symbol to be placed. Afterwards, the client device 606 may display the selected symbol at the selected location. The selected symbol may be superimposed over any image or other content that is already being displayed in the presentation canvas 116.

As illustrated in FIG. 12, in some implementations, the user interface 708 may provide a full-screen view of the presentation canvas 116 with unaltered access to at least some of the toolbar 740. For example, when the button 752 is pressed, the electronic device may display the presentation canvas 116 in full-screen view while concurrently displaying the toolbar 740. Doing so may increase the precision with which the user can annotate the image in the presentation canvas 116 with overlay symbols and shapes as it may significantly enhance the user's attention to detail.

The full-screen view of the presentation canvas 116 may be any view that is larger than the view in which the canvas is displayed concurrently with the VPW. In some implementations, when the presentation canvas 116 is displayed in full-screen view, the presentation canvas may occupy substantially the entire window in which the user interface is displayed (e.g., 100% of the window, 90% of the window, 85% of the window, etc.). Furthermore, as illustrated above, when the presentation canvas 116 is displayed in full-screen view one or more interface components, such as the VPW 114 and the clip bin viewer 126 may be hidden.

According to aspects of the disclosure, any of the shape overlay button 748 and the symbol overlay button 750 may be dynamically included in the user interface 708 based on the availability of custom symbol libraries in the clip bin associated with the VMR session. For example, when the VMR session is started (and/or the user interface 708 is launched), the client device 606 may perform a search for symbol libraries in the clip bin associated with the VMR session. Next, for each symbol library that is discovered, the client device 606 may generate a different overlay button and display the generated overlay button in the toolbar 740. Afterwards, when the content overlay button is pressed, the client device 606 may display a menu containing the symbols in the button's respective symbol library, thereby permitting the user to drag and drop any of the symbols in the menu onto the presentation canvas.

According to aspects of the disclosure, the user client device 606 may snip a portion of any content that is displayed in the presentation canvas 116 and make it into an overlay item for annotating images and/or other content that is subsequently displayed in the presentation canvas 116. More specifically, when the new overlay button 754 is pressed, the client device 606 may transition into a selection mode. While the client device 606 is in the selection mode, the client device 606 may detect a selection by the user of a portion of the content displayed in the presentation canvas 116 and generate an image including the selected portion of content. Afterwards, the client device 606 may include the image in one of the overlay libraries that are accessible via the shape overlay button 748 and the symbol overlay button 750, thereby permitting the user to annotate with the image content that is subsequently displayed in the presentation canvas 116.

FIG. 13 is a flowchart of an example of a process 1300 for conducting a VMR session, according to aspects of the disclosure. The VMR session may be conducted via the CMS 604, and the client device 606 may participate in it along with the client devices 608 and 610. At task 1310, a virtual collaboration environment for the VMR session is defined. The virtual collaboration environment may be defined in the manner discussed with respect to task 210 and FIG. 4. Afterwards, at task 1320, the VMR session is conducted by using the virtual collaboration environment. During the conduct of the VMR session, various operations may be performed by the client device 606 and/or the CMS 604. Some of these operations are discussed further below with respect to FIGS. 14A-17. And finally, at task 1330, the VMR session is concluded. The VMR session may be concluded in the manner discussed with respect to task 230.

FIG. 14A is a flowchart of an example of a process 1400A for tracking an object that appears in the video player window during the VMR session, in accordance with various aspects of the present disclosure.

At task 1410A, the client device 606 enters a tracking mode. In some implementations, the client device 606 may enter the tracking mode in response to detecting a predetermined input, such as a pressing of the track button 710a.

At task 1420A, the client device 606 detects a selection of an object that appears in the video player window. In some implementations, the object may be selected by the user through use of a symbol (i.e. crosshair) selected from a symbol menu.

At task 1430A, a frame from the video displayed in the VPW 114 is selected. The frame may be selected by either one of the client device 606 and the CMS 604.

At task 1440A, the position of the selected object is identified in the selected frame. The position may be identified by using any suitable image recognition technique. The position of the selected object may be identified by either one of the client device 606 and the CMS 604.

At task 1450A, an indication of the position of the object in the frame is transmitted to one or more of the participants in the VMR session. In implementations in which tasks 1430A-1450A are performed by the client device 606, the client device 606 may transmit the indication of the object's position to at least one other client device that is participating in the VMR session. Furthermore, in some implementations, the client device 606 may transmit to the at least one other client device an indication of an overlay item (e.g., a symbol, shape, or custom overlay item), such as the marker 810, that is used to mark the position of the object. Additionally, or alternatively, the client device 606 may transmit the indication of the object's position to the CMS 604 for further distribution to other VMR session participants.

Alternatively, in implementations in which tasks 1430A-1450A are performed by the CMS 604, the CMS 604 may transmit the indication of the object's position to the client device 606 and/or at least one other client device that is participating in the VMR session. Furthermore, in some implementations, the CMS 604 may transmit to the client device 606 and the at least one other client device an indication of an overlay item (e.g., a symbol, shape, or custom overlay item), such as the marker 810, that is used to mark the position of the object.

At task 1460A, the client device 606 displays the frame selected at task 1430A in the presentation canvas 116. Furthermore, the client device may superimpose an overlay item (e.g., the marker 810) on the presentation canvas 116 based on the object's location. As illustrated in FIG. 8, the overlay item may be superimposed on the object. Alternatively, in some implementations, the overlay item may be displayed at a position adjacent to the object, and/or at any other suitable location in the presentation canvas 116.

At task 1470A, the client device 606 determines whether to exit the tracking mode. If the client device 606 determines to exit the tracking mode, the process proceeds to task 1330. If the client device determines not to exit the tracking mode, the presentation canvas 116 is refreshed by executing tasks 1430A-1450A again. As discussed above, the presentation canvas may be refreshed twice every second and/or at any other suitable rate.

FIG. 14B is a flowchart of an example of a process 1400B for tracking an object that appears in video shown in the VPW 114, in accordance with various aspects of the present disclosure.

At task 1410B, the client device 606 enters tracking mode.

At task 1420B, the client device 606 begins playing video in the VPW 114 of the user interface 708.

At task 1430B, the client device 606 detects a selection of an object that appears in a first frame of the video. As discussed above, the selection may be performed via an input to the VPW 114 that defines a particular shape (e.g., a circle or rectangle) around the object.

At task 1440B, the client device transmits to the CMS 604 an indication of the selection to the CMS 604. More particularly, in some implementations, the client device may transmit to the CMS 604 an indication of the first frame (e.g., an ID belonging to the first frame or the first frame itself) and an indication of the location of the object in the first frame (e.g., coordinates of the object in the first frame and/or size of the shape that is defined by the user to select the object). Furthermore, in some implementations, the client device 606 may transmit to the CMS 604 an instruction to cause all (or at least some) participants in the CMS 604 to enter the tracking mode. Upon receiving the indication of the position of the object in the first frame, the CMS 604 may begin tracking the object in the video in the manner discussed with respect to tasks 1430A-1450A.

At task 1450B, the client device 606 receives an indication of the position of the second object in a second frame. Additionally, in some implementations, the client device may receive the second frame, as well.

At task 1460B, the client device 606 displays the second frame in the presentation canvas along with an overlay item marking the location of the second object in the second frame. For example, as illustrated in FIG. 8, the client device 606 may superimpose the overlay item on the object.

At task 1470B, the client device 606 determines whether to exit the tracking mode. If the client device 606 determines to exit the tracking mode, the process proceeds to task 1330. If the client device determines not to exit the tracking mode, the presentation canvas 116 is refreshed by executing tasks 1450B-1460B again.

Although not shown FIGS. 14A-B, in some implementations, only users who have a certain level of privileges (e.g., administrative privileges) may be permitted to transition the VMR session into tracking mode (i.e., permitted to activate the tracker). For example, in instances in which the object tracking is initiated at a client device other than the client device 606, the client device 606 may receive from the CMS 604 (or the other client device) a stream of frames from the video along with an indication of the position in each frame of the object being tracked. In addition, the client device 606 may receive an instruction from the CMS 604 (or the other client device) to begin displaying the stream of frames in the presentation canvas and/or an indication of an overlay item, such as the marker 810 that is to be used to mark the location of the object. In response to the instruction, the client device 606 may begin displaying the stream of frames on the presentation canvas 116. As discussed above, the client device 606 may superimpose the overlay item on each of the frames at a position that is based on the location of the object. For example, the client device 606 may superimpose the overlay item onto the object, adjacently to the object, etc. For example, the stream of frames may include every 10^{th} frame of the video. Alternatively, in some implementations, the overlay item may be merged into the frames in the stream prior to them being transmitted to the client device 606.

FIG. 14C is a flowchart of an example of a process 1400C for tracking objects in video content, in accordance with various aspects of the present disclosure.

At task 1410C, the client device 606 enters tracking mode.

At task 1420C, the client device 606 begins playing video in the VPW 114 of the user interface 708.

At task 1430C, the client device 606 detects a selection of a first location in a frame of the video. The selection may be performed via any suitable type of input. For example, in some implementations, the selection may be performed by the user placing a mouse cursor at the first location. Additionally or alternatively, as another example, the selection may be performed by the user placing his or her finger over the first location.

At task 1440C, the client device 606 identifies a second location in the frame based on the first location. For example, the second location may be the same as the first location or a location that is offset from the first location by some distance.

At task 1450C, the client device 606 displays the frame of the video in the presentation canvas.

At task 1460C, the client device 606 displays an overlay item in the presentation canvas at the second location. The overlay item may include any suitable type of marker, such as the marker 810, which is shown in FIG. 8.

At task 1470C, the client device transmits an indication of at least one of the frame, the first location, the second location, and the overlay item to one or more participants in the VMR session. The indication may be transmitted directly to the participants or via the CMS 604. Upon receiving the indication, any of the client devices may display the frame along with the overlay item in its respective presentation canvas. As discussed above, the overlay item may be superimposed on the frame at the second location.

At task 1480C, the client device 606 determines whether to exit the tracking mode. If the client device 606 determines to exit the tracking mode, the process proceeds to task 1330. If the client device determines not to exit the tracking mode, the process returns to operation 1430C and the presentation canvas is refreshed.

Although in the present example, the overlay item and the video frame are displayed in the presentation canvas of the client device 606 and/or other client device(s) that participate in the VMR session, in some implementations this may not be the case. For example, the overlay item may be displayed at the first location in the VPW 114 of the client device 606 and/or other client device(s) that participate in the VMR session without displaying the frame and or the overlay item in the respective presentation canvases of the client device 606 and/or the other client devices.

FIG. 15 is a flowchart of an example of a process 1500, in accordance with various aspects of the present disclosure. At task 1510, a predetermined type of instruction is detected by the client device 606. The instruction may be to join the VMR session, an instruction to launch a VMR interface (e.g., the user interface 708), and/or any other suitable type of instruction. At task 1520, a search is performed of a clip bin associated with the VMR session and one or more overlay libraries are identified as a result of the search. According to aspects of the disclosure, each overlay library may include one or more files that represent an overlay item (or a collection of overlay items) that can be superimposed on the presentation canvas 116. Each overlay item may include a shape, a text symbol, an image, and/or any other suitable type of content. At task 1530, a different overlay button is generated for each overlay library that is identified as a result of the search, after which the overlay button is added to a toolbar (e.g., the toolbar 740) that is part of an interface for conducting the VMR session (e.g., the user interface 708). Subsequently, when the overlay button is pressed, the client device 606 may display a menu (e.g., the shape overlay menu 1110) including at least some of the overlay items in the input component's associated overlay library.

For example, in some implementations, the client device 606 (or the CMS 604) may perform a search of the clip bin associated with the communications session to determine whether any of the files stored in the clip bin corresponds to an overlay library. In some implementations, a file may be considered to correspond to the overlay library if it includes one or more overlay items. Additionally, or alternatively, in some implementations, a file may be considered to correspond to the overlay library if identifies one or more other files that include overlay items; the other files may be identified directly and/or indirectly. Next, when the client device 606 (or the CMS 604) detects that a given file corresponds to an overlay library, the client device 606 (or the CMS 604) may include in the user interface 708 an input component (e.g., a button, icon, etc.) for accessing one or more overlay items that are part of the overlay library. When the input component is activated (e.g., pressed, touched, etc.), a menu including one or more of the overlay items in the library may be displayed. The menu may include any suitable type of interface which permits selection of overlay items. When one of the overlay items is selected, that overlay item may be superimposed on the presentation canvas 116 at a user-specified location. In other words, the user may annotate the presentation canvas 116 by placing the overlay item on it.

As noted, the symbol library scan and additions may be performed either locally by any of the client devices that participate in the VMR session or in a centralized fashion by the CMS 604. In instances in which a web-based interface provided by the CMS 604 is used by the participants in the VMR session, the addition to the user interface 708 of an input component for accessing the overlay menu may be performed by the CMS 604.

FIG. 16 is a flowchart of an example of a process 1600, in accordance with various aspects of the present disclosure.

At task 1610, a base item is displayed in the presentation canvas 116 by the client device 606. The base item may include an image, text, and/or any other suitable type of content.

At task 1620, one or more annotations are displayed/made over the base item in the presentation canvas 116. Any of the annotations may include an image, text, a symbol, a shape, and/or any other suitable type of content. The annotations may be made by superimposing various annotation items on the canvas 116, such as annotation items (e.g., symbols and shapes) that are accessible via the buttons 748 and 750.

At task 1630, an input selecting a portion of the presentation canvas 116 is detected at the client device 606. For example, the input may be one that defines a particular shape (e.g., a circle) around a portion of the presentation canvas.

At task 1640, a new overlay item is created in response to the input. The new overlay item may include an image (e.g., a png image) or any other suitable type of content. In the present example, the new overlay item is in an image. In some implementations, the new overlay item may include a portion of the base item that is selected by the user. Additionally, or alternatively, in some implementations, the new overlay item may include one or more of the annotations that are displayed over the selected portion of the base item.

At task 1650, an annotation toolbar (e.g., the toolbar 740) associated with the presentation canvas 116 is arranged (e.g., updated) to provide access to the newly-created overlay item. In some implementations, the newly-created overlay item may be added to an existing overlay library that is stored in the clip bin associated with the VMR session. Alternatively, in some implementations, a new overlay library may be created that includes the newly-created overlay item and stored in the clip bin associated with the VMR session. In such instances, a new annotation input component (e.g., an overlay button) may be displayed in an annotation toolbar associated with the presentation canvas (e.g., the toolbar 740). Additionally, or alternatively, in some implementations, the new overlay item may be stored locally on the client device 606.

At task 1660, the creation of the new overlay item is signaled to other participants in the VMR session. In some implementations, at task 1660, a notification of the creation of the new overlay item and/or an identification of the overlay library in which the new overlay item is stored may be transmitted to one or more of the participants in the VMR session. Additionally, or alternatively, in some implementations, the newly-created overlay item may be transmitted to one or more of the other participants in the VMR session. The signal may be transmitted in any suitable manner. For example, the signal may be transmitted directly to the other VMR session participants or via the content management system (e.g., CMS 604) that is used to conduct the VMR session. In instances in which the new overlay item is generated by the CMS 604, the CMS 604 may provide the signal and/or new overlay item to the client device 606 and/or all participants in the VMR session.

At task 1670, the presentation canvas 116 is updated and a new base image is displayed in it.

At task 1680, the new base image is annotated with the newly-created overlay item. For example, the new base image may be annotated based on: (i) a first input that selects one of the overlay input components displayed in the annotation toolbar, and (ii) a second input that selects the newly-created overlay item from a menu that is displayed in response to the first input. As discussed above, when the presentation canvas 116 is annotated by the user of the client device 606, the annotation may appear in the respective presentation canvases of all participants in the VMR session.

FIG. 17 is a flowchart of an example of a process 1700, in accordance with various aspects of the present disclosure.

At task 1710a, a base item and/or one or more annotations are displayed in the presentation canvas 116 while the VMR session is being conducted.

At task 1720, a canvas update event is detected by the client device 606. In some implementations, the canvas update event may be one that is generated by the CMS 604 when an instruction is received from the client device 606 to display a new base item in the presentation canvas. Additionally, or alternatively, the canvas update event may be one that is generated by the client device 606 when an input is received by the client device 606 instructing it to display the new base item in the presentation canvas.

At task 1730, a screenshot of the presentation canvas is saved before the new image is displayed. In some implementations, the screenshot may include the base item. Additionally, or alternatively, in some implementations, the screenshot may include all annotations that have been made on the presentation canvas while the base item is displayed. The screenshot may be saved as a web-compatable image file (e.g., a png). The screenshot may be saved in the clip bin associated with the VMR session or at any other suitable storage location.

At task 1740, a data structure is updated to include a reference to the screenshot. In some implementations, the data structure may include a reference to all screenshots that have been generated during a predetermined period. For example, the data structure may include a reference to all screenshots generated over the course of the entire VMR session or within the past 30 minutes. In some implementations, the data structure may include an ordered list of identifiers, wherein each of the identifiers corresponds to a different presentation canvas screenshot that is stored in the clip bin associated with VMR session. As discussed above, in some implementations, the identifiers in the data structure may be displayed in the content list 722.

At task 1750, the data structure is modified. For example, modifying the data structure may include deleting a selected identifier from it. As discussed with respect to FIG. 7, when a particular screenshot is selected from the content list 722, and the delete button 724c is pressed, the identifier corresponding to the screenshot may be deleted from the data structure (and/or the content list 722). As another example, when a particular screenshot is selected from the content list 722, and one of the buttons 724a and 724b is pressed, the identifier of the screenshot may be moved by one position in the data structure (and/or the content list 722).

At task 1760, a document including the screenshots identified in the data structure is generated and stored in the clip bin associated with the VMR session (or another storage location). The document may be a PDF document, a WORD document, and/or any other suitable type of document. In some implementations, each page in the document may include a different one of the presentation canvas screenshots that are identified in the presentation canvas. Additionally, or alternatively, in some implementations, the pages/screenshots may be arranged in the document in the same order as the screenshots respective identifiers in the data structure.

Although in the present example screenshots of the presentation canvas are automatically saved when the base item shown in the presentation canvas is changed, in some implementations the screenshots may be saved when a predetermined user input is detected. For example, the screenshots may be saved when a button, such as the save button 746, is pressed. In some implementations, the screenshots of the presentation canvas may be saved temporarily until the end of the VMR session. Alternatively, in some implementations, the screenshots may remain saved for an unspecified period that lasts beyond the duration of the of the VMR session. As discussed above, the document may be generated when a particular input component, such as the document button 724d, is activated (e.g., pressed, touched, etc.)

FIGS. 1-17 are provided as examples only. At least some of the tasks discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

Although the examples above are provided in the context of a video player window 114 and collaboration canvas 116, it will be appreciated that any of the video player window 114 and collaboration canvas can be replaced with any suitable type of canvas that is in some manner operable to display visual content (e.g., text, still images, video, etc.) As used herein, the term “canvas” may refer to any suitable type of user interface component that can be used to display visual content, such as, for example, video, images, files, etc. Furthermore, although the examples presented throughout the disclosure use “buttons” as the primary input component used to illicit action by a client device and/or content management system, it is to be understood that any of the buttons discussed throughout the specification may be replaced with any suitable type of input component (e.g., an icon, active text, etc.) that can cause a device (e.g., a client device or a content management system) to perform an action when that input component is activated (e.g., pressed, selected, touched, etc.).

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Although some of the above examples are provided in the context of an IP camera and IP stream, it is to be understood that any suitable type of networked camera and/or media stream can be used instead. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. While the present disclosure has been particularly shown and described with reference to the examples provided therein, it is to be understood by those skilled in the art that various changes in form and details may be made therein without departing from the spirit and scope of the present disclosure as defined by the appended claims.

What is claimed is:

1. A method for conducting a communications session comprising:
displaying, by a client device, a communications interface including a first canvas, a second canvas, and a content browser, wherein: the first canvas is arranged to display a media stream, the second canvas is arranged to display a sequence of content items provided by a communications system, and the content browser is arranged to display identifiers for one or more document files that are associated with the communications session;
detecting a first input that selects a document file from the content browser;
in response to the first input, transmitting, from the client device to the communications system, an instruction to provide a new sequence of content items that corresponds to the document file; and
displaying the new sequence of content items in the second canvas, wherein each content item in the new sequence is generated by converting a different portion of the document file from a document format to another format,
wherein at least one of the document files identified in the content browser is associated with the communications session before the communications session is started, and the content browser is displayed during the communications session.

2. The method of claim 1, further comprising:
detecting, by the client device, a second input to the second canvas; and
annotating, in response to the second input, a content item displayed in the second canvas and transmitting, to the communications system, an instruction to disseminate the annotation among one or more other client devices that participate in the communications session.

3. The method of claim 1, further comprising:
detecting, by the client device, a second input to the first canvas; and
hiding, in response to the second input, a first content item from the second canvas and displaying a second content item in the second canvas.

4. The method of claim 1, further comprising:
detecting a second input selecting an object that appears in a first frame of the media stream;
transmitting an indication of the object to the communications system;
receiving, from the communications system, an indication of a location of the object in a second frame of the media stream; and
displaying, in the second canvas, the second frame of the media stream and an indication of the location of the object in the second frame.

5. The method of claim 4, wherein displaying the indication of the location of the object in the second frame includes superimposing an overlay item on the object.

6. The method of claim 1, further comprising:
detecting a selection of an object that appears in a first frame of the media stream; and
displaying, in the second canvas, a plurality of frames of the media stream,
wherein the object appears in each of the plurality of frames, and
wherein each respective frame in the plurality is displayed with an overlay item superimposed on the respective frame, the overlay item indicating a location of the object the respective frame.

7. The method of claim 1, wherein the communications interface further includes an input component for annotating the second canvas, the method further comprising hiding the first canvas and displaying the second canvas in full-screen view while continuing to display the input component for annotating the second canvas.

8. The method of claim 1, further comprising:
detecting whether a file associated with the communications session corresponds to an overlay library;
in response to detecting that the file corresponds to the overlay library, including in the communications interface, an input component that is associated with the overlay library; and
in response to detecting that the input component is activated, displaying a menu containing at least one overlay item that is part of the overlay library.

9. The method of claim 1, further comprising:
displaying a first content item in the second canvas;
detecting an input to the second canvas selecting a portion of the first content item;
generating an overlay item based on the input, the overlay item including the portion of the content item and one or more annotations to the portion;
displaying a second content item in the second canvas; and
superimposing the overlay item on the second content item.

10. The method of claim 1, further comprising:
generating and storing a plurality of screenshots of the second canvas;
displaying an interface component including a plurality of screenshot identifiers, each screenshot identifier corresponding to a different one of the plurality of screenshots;
changing an order in which the screenshot identifiers are arranged in the interface component in response to a second input; and
generating a document including the plurality of screenshots, wherein an order in which the screenshots are arranged in the document is based on an order in which the screenshot identifiers are arranged in the interface component.

11. An electronic device for conducting a communications session, comprising at least one processor, configured to:
present, on a display, a communications interface including a first canvas, a second canvas, and a content browser, wherein: the first canvas is arranged to display a media stream, the second canvas is arranged to display a sequence of content items provided by a communications system, and the content browser is arranged to display identifiers for one or more document files that are associated with the communications session;
detect a first input that selects a document file from the content browser;
in response to the first input, transmit to the communications system an instruction to provide a new sequence of content items that corresponds to at least a portion of the document file; and
display the new sequence of content items in the second canvas, wherein each content item in the new sequence is generated by converting a different portion of the document file from a document format to another format, and
wherein at least one of the document files identified in the content browser is associated with the communications session before the communications session is started, and the content browser is displayed during the communications session.

12. The electronic device of claim 11, wherein the processor is further configured to:
detect a second input to the second canvas; and
annotate, in response to the second input, a content item displayed in the second canvas and transmit an instruction to disseminate the annotation among one or more other client devices that participate in the communications session.

13. The electronic device of claim 11, wherein the processor is further configured to:
detect a second input to the first canvas;
hide, in response to the second input, a first content item from the second canvas and display a second content in the second canvas.

14. The electronic device of claim 11, wherein the at least one processor is further configured to:
detect a second input selecting an object that appears in a first frame of the media stream;
transmit an indication of the object to the communications system;
receive, from the communications system, an indication of a location of the object in a second frame of the media stream; and
display, in the second canvas, the second frame of the media stream and an indication of the location of the object in the second frame.

15. The electronic device of claim 14, wherein displaying the indication of the location of the object in the second frame includes superimposing an overlay item on the object.

16. The electronic device of claim 11, further comprising:
detect a selection of an object that appears in a first frame of the media stream; and
display, in the second canvas, a plurality of frames of the media stream,
wherein the object appears in each of the plurality of frames, and
wherein each respective frame in the plurality is displayed with an overlay item superimposed on the respective frame, the overlay item indicating a location of the object the respective frame.

17. The electronic device of claim 11, wherein the communications interface further includes an input component for annotating the second canvas, and the at least one processor is further configured to hide the first canvas and display the second canvas in full-screen view while continuing to display the input component for annotating the second canvas.

18. The electronic device of claim 11, wherein the at least one processor is further configured to:
detect whether a file associated with the communications session corresponds to an overlay library;
in response to detecting that the file corresponds to the overlay library, include in the communications interface, an input component that is associated with the overlay library; and
in response to detecting that the input component is activated, display a menu containing at least one overlay item that is part of the overlay library.

19. The electronic device of claim 11, wherein the at least one processor is further configured to:
display a first content item in the second canvas;
detect an input to the second canvas selecting a portion of the first content item;
generate an overlay item based on the input, the overlay item including the portion of the content item and one or more annotations to the portion;
display a second content item in the second canvas; and
superimpose the overlay item on the second content item.

20. The electronic device of claim 11, wherein the at least one processor is further configured to:
generate and store a plurality of screenshots of the second canvas;
display an interface component including a plurality of screenshot identifiers, each screenshot identifier corresponding to a different one of the plurality of screenshots;
change an order in which the screenshot identifiers are arranged in the interface component in response to a second input; and
generate a document including the plurality of screenshots, wherein an order in which the screenshots are arranged in the document is based on an order in which the screenshot identifiers are arranged in the interface component.
